(19) United States
(12) Patent Application Publication
(10) Pub. No.: US 2026/0356752 A1
(43) Pub. Date: Nov. 12, 2026

(54) COAL-DERIVED CHAR-BASED GROUT AND METHODS OF MAKING THE SAME

(71) Applicant: UNIVERSITY OF WYOMING, Laramie, WY (US)

(72) Inventors: Hua YU, Laramie, WY (US); Kam Weng NG, Laramie, WY (US); Prayush JONCHHE, Laramie, WY (US); Chooi Kim LAU, Laramie, WY (US)

(21) Appl. No.: 19/125,885

(22) PCT Filed: Oct. 31, 2023
(86) PCT No.: PCT/US2023/036459

§ 371 Date: Apr. 30, 2025

Related U.S. Application Data
(60) Provisional application No. 63/421,001, filed on Oct. 31, 2022.
(60) Provisional application No. 63/522,938, filed on Jun. 23, 2023.

(51) Int. Cl. C04B 18/06; C04B 40/00; C04B 111/70

(52) U.S. Cl. CPC C04B 18/065; C04B 40/0028; C04B 2111/70

(57) ABSTRACT

Embodiments of the present disclosure related pyrolysis char grout (PCG). The PCG includes a cured composition. The cured composition includes about 10% to about 50% pyrolysis char (PC) by weight and about 50% to about 90% cement materials by weight. The composition has a water to cement (w/c) ratio of about 0.4 to about 1.2. A method of making a composition includes sieving a pyrolysis char (PC), mixing the PC with cement materials to form a dry mixture, mixing the dry mixture with water to form a PCG mixture, and curing the PCG mixture to form a PCG.

### BACKGROUND

### Field

Embodiments of the present disclosure generally relate to grout materials. In particular, the disclosure relates to pyrolysis char grout (PCG) and methods of fabricating PCG using coal-derived pyrolysis char (PC).

### Description of Related Art

Coal currently serves an important role as an energy source but the increasing demand for renewable energy has reduced the production and consumption of coal in the United States of America (USA). Coal is carbon-rich, and its use in energy generation may affect atmospheric CO₂ levels. The air pollution and global environmental issues associated with the combustion of coal have limited the continuous application of coal in energy production. Specifically, according to the Bureau of Safety and Environmental Enforcement (BSEE), global warming that results from various greenhouse gas emissions is partly due to fossil fuel burning, such as the combustion of coal.

Wyoming Powder River Basin (PRB) coal plays an important role in the Wyoming energy industry as well as other coal plays in different parts of the United States and the world more generally. However, renewable energy is slowly replacing the coal industry, causing the market price of coal to drop. Thus, to attract new investment through technological innovation and support coal mine operations, environmentally friendly methods to create new diversified coal products are needed.

Grouting is a process of injecting liquids, semi-solids mixtures, or mixed suspensions under pressure. In civil engineering, grouts have been used as soil stabilizers, filing for rock fractures, rehabilitation of structures, and precast constructions. Cement based grout is common used in these applications. However, a major component of cement and its production is harmful to the environment. Carbon dioxide emissions from cement production contribute about 8%-10% of global CO₂ emission annually. Further, cement based grouts have issues with bleeding, or segregation of cement and water in the grout, leading to inferior performance.

Therefore, there is a need for improved grout and methods of fabricating grout using coal-derived pyrolysis char.

### SUMMARY

In one embodiment, a composition is described herein. The composition includes about 10% to about 50% pyrolysis char (PC) by weight and about 50% to about 90% cement materials by weight. The composition has a water to cement (w/c) ratio of about 0.4 to about 1.2.

In another embodiment, a pyrolysis char grout is disclosed. The PCG includes a cured composition. The cured composition includes about 10% to about 50% pyrolysis char (PC) by weight and about 50% to about 90% cement materials by weight. The composition has a water to cement (w/c) ratio of about 0.4 to about 1.2.

In yet another embodiment, a method of forming a carbon based grout from a composition is described herein. The method of making a composition includes sieving a pyrolysis char (PC), mixing the PC with cement materials to form a dry mixture, mixing the dry mixture with water to form a PCG mixture, and curing the PCG mixture to form a PCG.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 illustrates a flow diagram of a method of forming a composition, according to embodiments.

FIG. 2A is a graph illustrating Marsh viscosity versus PC content of PCG samples having a PC particle size of less than 300 μm, according to embodiments.

FIG. 2A is a graph illustrating Marsh viscosity versus PC content of PCG samples having a PC particle size from 300 μm to 850 μm, according to embodiments.

FIG. 3A is a graph illustrating the bleeding percentage versus time of PCG samples having a w/c ratio of 0.8 and a PC particle size of less than 300 μm, according to embodiments.

FIG. 3B is a graph illustrating the bleeding percentage versus time of PCG samples having a w/c ratio of 1.0 and a PC particle size of less than 300 μm, according to embodiments.

FIG. 3C is a graph illustrating the bleeding percentage versus time of PCG samples having a w/c ratio of 1.2 and a PC particle size of less than 300 μm, according to embodiments.

FIG. 3D is a graph illustrating the bleeding percentage versus time of PCG samples having a w/c ratio of 0.8 and a PC particle size of 300 μm to 850 μm, according to embodiments.

FIG. 3E is a graph illustrating the bleeding percentage versus time of PCG samples having a w/c ratio of 1.0 and a PC particle size of 300 μm to 850 μm, according to embodiments.

FIG. 3F is a graph illustrating the bleeding percentage versus time of PCG samples having a w/c ratio of 1.2 and a PC particle size of 300 μm to 850 μm, according to embodiments.

FIG. 4A is a graph illustrating the final bleeding percentage of PCG samples having a PC particle size of less than 300 μm, according to embodiments.

FIG. 4B is a graph illustrating the bleeding percentage versus time of PCG samples having a PC particle size of 300 μm to 850 μm, according to embodiments.

FIG. 5A is a graph illustrating the shear stress-shear rate relationship of PCG having a w/c ratio of 0.8 and a PC particle size of less than 300 μm, according to embodiments.

FIG. 5B is a graph illustrating the shear stress-shear rate relationship of PCG having a w/c ratio of 0.8 and a PC particle size of 300 μm to 850 μm, according to embodiments.

FIG. 6A is a graph illustrating the viscosity-shear rate relationship of PCG having a w/c ratio of 0.8 and a PC particle size of less than 300 μm, according to embodiments.

FIG. 6B is a graph illustrating the viscosity-shear rate relationship of PCG having a w/c ratio of 0.8 and a PC particle size of 300 μm to 850 μm, according to embodiments.

FIG. 7A is a graph illustrating the shear stress-shear rate relationship of PCG having a w/c ratio of 1.0 and a PC particle size of less than 300 μm, according to embodiments.

FIG. 7B is a graph illustrating the shear stress-shear rate relationship of PCG having a w/c ratio of 1.0 and a PC particle size of 300 μm to 850 μm, according to embodiments.

FIG. 8A is a graph illustrating the viscosity-shear rate relationship of PCG having a w/c ratio of 1.0 and a PC particle size of less than 300 μm, according to embodiments.

FIG. 8B is a graph illustrating the viscosity-shear rate relationship of PCG having a w/c ratio of 1.0 and a PC particle size of 300 μm to 850 μm, according to embodiments.

FIG. 9A is a graph illustrating the shear stress-shear rate relationship of PCG having a w/c ratio of 1.2 and a PC particle size of less than 300 μm, according to embodiments.

FIG. 9B is a graph illustrating the shear stress-shear rate relationship of PCG having a w/c ratio of 1.2 and a PC particle size of 300 μm to 850 μm, according to embodiments.

FIG. 10A is a graph illustrating the viscosity-shear rate relationship of PCG having a w/c ratio of 1.2 and a PC particle size of less than 300 μm, according to embodiments.

FIG. 10B is a graph illustrating the viscosity-shear rate relationship of PCG having a w/c ratio of 1.2 and a PC particle size of 300 μm to 850 μm, according to embodiments.

FIG. 11A is a graph illustrating the X-ray diffraction (XRD) of PC, according to embodiments.

FIG. 11B is a graph illustrating the thermogravimetric (TG) analysis and differential thermal (DT) analysis of PC, according to embodiments.

FIG. 12A is a graph illustrating the density versus PC content of a −25PCG sample with a 7 day cure (−25PCG/7 d), according to embodiments.

FIG. 12B is a graph illustrating the density versus PC content of a −25PCG sample with a 28 day cure (−25PCG/28 d), according to embodiments.

FIG. 12C is a graph illustrating the density versus PC content of a 5PCG sample with a 7 day cure (5PCG/7 d), according to embodiments.

FIG. 12D is a graph illustrating the density versus PC content of a 5PCG sample with a 7 day cure (5PCG/28 d), according to embodiments.

FIG. 12E is a graph illustrating the density versus PC content of a 25PCG sample with a 7 day cure (25PCG/7 d), according to embodiments.

FIG. 12F is a graph illustrating the density versus PC content of a 25PCG sample with a 7 day cure (25PCG/28 d), according to embodiments.

FIG. 12G is a graph illustrating the density versus PC content of a 35PCG sample with a 7 day cure (35PCG/7 d), according to embodiments.

FIG. 12H is a graph illustrating the density versus PC content of a 35PCG sample with a 7 day cure (35PCG/28 d), according to embodiments.

FIG. 13A is a graph illustrating the thermogravimetric (TG) analysis and differential thermal (DT) analysis of PCG samples cured for 7 days, according to embodiments.

FIG. 13B is a graph illustrating the TG analysis and DT analysis of PCG samples cured for 28 days, according to embodiments.

FIG. 14A is a scanning electron microscopy (SEM) micrograph of a PCG sample having 20% PC at −25 °C curing temperature for 28 days, according to embodiments.

FIG. 14B is a SEM micrograph of a PCG sample having 20% PC at 5 °C curing temperature for 28 days, according to embodiments.

FIG. 14C is a SEM micrograph of a PCG sample having 20% PC at 25 °C curing temperature for 28 days, according to embodiments.

FIG. 14D is a SEM micrograph of a PCG sample having 20% PC at 35 °C curing temperature for 28 days, according to embodiments.

FIG. 15 is a graph illustrating an X-ray diffraction (XRD) analysis of PCG samples cured for 28 days, according to embodiments.

FIG. 16 is a XRD analysis of precipitates collected from PCG samples at different temperatures, according to embodiments.

FIG. 17A is a graph illustrating the compressive strength versus PC content of PCG samples cured at −25 °C for 7 days, according to embodiments.

FIG. 17B is a graph illustrating the compressive strength versus PC content of PCG samples cured at −25 °C for 28 days, according to embodiments.

FIG. 17C is a graph illustrating the compressive strength versus PC content of PCG samples cured at 5 °C for 7 days, according to embodiments.

FIG. 17D is a graph illustrating the compressive strength versus PC content of PCG samples cured at 5 °C for 28 days, according to embodiments.

FIG. 17E is a graph illustrating the compressive strength versus PC content of PCG samples cured at 25 °C for 7 days, according to embodiments.

FIG. 17F is a graph illustrating the compressive strength versus PC content of PCG samples cured at 25 °C for 28 days, according to embodiments.

FIG. 17G is a graph illustrating the compressive strength versus PC content of PCG samples cured at 35 °C for 7 days, according to embodiments.

FIG. 17H is a graph illustrating the compressive strength versus PC content of PCG samples cured at 35 °C for 28 days, according to embodiments.

FIG. 18A is a graph illustrating the linear heat flow versus time of PCG samples having a w/c ratio of 0.8, according to embodiments.

FIG. 18B is a graph illustrating the logarithmic heat flow versus time of PCG samples having a w/c ratio of 0.8, according to embodiments.

FIG. 18C is a graph illustrating the linear heat flow versus time of PCG samples having a w/c ratio of 1.0, according to embodiments.

FIG. 18D is a graph illustrating the logarithmic heat flow versus time of PCG samples having a w/c ratio of 1.0, according to embodiments.

FIG. 18E is a graph illustrating the linear heat flow versus time of PCG samples having a w/c ratio of 1.2, according to embodiments.

FIG. 18F is a graph illustrating the logarithmic heat flow versus time of PCG samples having a w/c ratio of 1.2, according to embodiments.

FIG. 19A is a graph illustrating the cumulative heat versus time relationship of PCG with a w/c ratio of 0.8, according to embodiments.

FIG. 19B is a graph illustrating the cumulative heat versus time relationship of PCG with a w/c ratio of 1.0, according to embodiments.

FIG. 19C is a graph illustrating the cumulative heat versus time relationship of PCG with a w/c ratio of 1.2, according to embodiments.

FIG. 19D is the cumulative heat versus time relationship of PCG and cement grout, according to embodiments.

FIG. 20A is a graph illustrating the shear strain-shear stress relationship of PCG cured at 5 °C with a w/c ratio of 0.8, according to embodiments.

FIG. 20B is a graph illustrating the shear strain-shear stress relationship of PCG cured at 35 °C with a w/c ratio of 0.8, according to embodiments.

FIG. 20C is a graph illustrating the shear strain-shear stress relationship of PCG cured at 5 °C with a w/c ratio of 1.0, according to embodiments.

FIG. 20D is a graph illustrating the shear strain-shear stress relationship of PCG cured at 35 °C with a w/c ratio of 1.0, according to embodiments.

FIG. 20E is a graph illustrating the shear strain-shear stress relationship of PCG cured at 5 °C with a w/c ratio of 1.2, according to embodiments.

FIG. 20F is a graph illustrating the shear strain-shear stress relationship of PCG cured at 35 °C with a w/c ratio of 1.2, according to embodiments.

FIG. 21A is a graph illustrating the viscosity-shear rate relationship of PCG at cured at 5 °C with a w/c ratio of 0.8, according to embodiments.

FIG. 21B is a graph illustrating the viscosity-shear stress relationship of PCG cured at 35 °C with a w/c ratio of 0.8, according to embodiments.

FIG. 21C is a graph illustrating the viscosity-shear stress relationship of PCG cured at 5 °C with a w/c ratio of 1.0, according to embodiments.

FIG. 21D is a graph illustrating the viscosity-shear stress relationship of PCG cured at 35 °C with a w/c ratio of 1.0, according to embodiments.

FIG. 21E is a graph illustrating the viscosity-shear stress relationship of PCG cured at 5 °C with a w/c ratio of 1.2, according to embodiments.

FIG. 21F is a graph illustrating the viscosity-shear stress relationship of PCG cured at 35 °C with a w/c ratio of 1.2, according to embodiments.

FIG. 22A is a graph illustrating the cumulative flow-shear rate relationship of PCG having a curing temperature of 5 °C and a w/c ratio of 0.8, according to embodiments.

FIG. 22B is a graph illustrating the cumulative flow-shear rate relationship of PCG having a curing temperature of 25 °C and a w/c ratio of 0.8, according to embodiments.

FIG. 22C is a graph illustrating the cumulative flow-shear rate relationship of PCG having a curing temperature of 35 °C and a w/c ratio of 0.8, according to embodiments.

FIG. 22D is a graph illustrating the cumulative flow-shear rate relationship of PCG having a curing temperature of 5 °C and a w/c ratio of 1.0, according to embodiments.

FIG. 22E is a graph illustrating the cumulative flow-shear rate relationship of PCG having a curing temperature of 25 °C and a w/c ratio of 1.0, according to embodiments.

FIG. 22F is a graph illustrating the cumulative flow-shear rate relationship of PCG having a curing temperature of 35 °C and a w/c ratio of 1.0, according to embodiments.

FIG. 22G is a graph illustrating the cumulative flow-shear rate relationship of PCG having a curing temperature of 5 °C and a w/c ratio of 1.2, according to embodiments.

FIG. 22H is a graph illustrating the cumulative flow-shear rate relationship of PCG having a curing temperature of 25 °C and a w/c ratio of 1.2, according to embodiments.

FIG. 22I is a graph illustrating the cumulative flow-shear rate relationship of PCG having a curing temperature of 35 °C and a w/c ratio of 1.2, according to embodiments.

FIG. 23A is a graph illustrating the PCG samples by different rheological models and corresponding R2 values having a curing temperature of 5 °C, according to embodiments.

FIG. 23B is a graph illustrating the PCG samples by different rheological models and corresponding R2 values having a curing temperature of 25 °C, according to embodiments.

FIG. 23C is a graph illustrating the PCG samples by different rheological models and corresponding R2 values having a curing temperature of 35 °C, according to embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to insulation foams and materials. In particular, the disclosure relates to insulation foams and methods of fabricating insulation foams using coal-derived pyrolysis char, lignin, and other chemical materials.

In one embodiment, a composition is described herein. The composition includes about 10% to about 50% pyrolysis char (PC) by weight and about 50% to about 90% cement materials by weight.

In another embodiment, a pyrolysis char grout (PCG) is described herein. The PCG includes a cured composition. The cured composition includes about 10% to about 50% PC by weight and about 50% to about 90% cement materials by weight.

In another embodiment, a method of forming a pyrolysis char grout (PCG) from a composition is described herein. The method of making a composition includes sieving a pyrolysis char (PC), mixing the PC with cement materials to form a dry mixture, mixing the dry mixture with water to form a PC grout (PCG) mixture, and curing the PCG to a PCG.

The inventors have found new and improved methods for fabricating PCG from coal-derived pyrolysis char (PC). Briefly, raw coal is thermo-chemically converted to produce PC. The resulting PC is then converted to grout materials such as pyrolysis char grout (PCG).

The desire for environmentally-friendly materials, energy savings, and reduced energy consumption in building materials can be addressed by the building materials described herein. Building materials made with PC material have low density, low thermal conductivity, and high thermal insulative properties. These materials, through recycling/reuse and decreasing the amount of energy usage in fabrication, further lessens the environmental impact of the PCG.

The use of headings is for purposes of convenience and does not limit the scope of the present disclosure. Embodiments described herein can be combined with other embodiments.

As used herein, a “composition” can include component(s) of the composition, reaction product(s) of two or more components of the composition, a remainder balance of remaining starting component(s), or combinations thereof. Compositions of the present disclosure can be prepared by any suitable mixing process.

### Compositions

Embodiments described herein generally relate to grout materials. In particular, the disclosure relates to pyrolysis char grout (PCG) and methods of fabricating PCG using coal-derived pyrolysis char.

A composition (e.g., a pyrolysis char grout (PCG) mixture) includes pyrolysis char (PC). The composition includes about 10% to about 50% PC by weight, such as about 20% to about 30% PC by weight. Pyrolysis char (PC) is formed from coal pyrolyzed at about 450 °C or greater, such as about 850 °C. PC includes at least about 75% to about 85% fixed carbon, about 12% to about 20% ash, and about 0.5% to about 2% volatile material. The cement materials may include Portland Type I cement and Portland Type II cement as per ASTM C150/C150M. The composition includes about 50% to about 90% cement materials by weight, such as about 70% to about 80% cement materials by weight. The composition includes a water/cement (w/c) ratio of about 0.4 to about 1.2

The composition has a bleeding percentage less than about 30%, such as less than about 20%, such as less than about 10%, such as less than about 5%. The Marsh viscosity of the composition is about 1 sec to about 120 sec, such as about 10 sec to about 80 sec, such as about 20 sec to about 40 sec. The PCG mixture may be cured to form a PCG. The density of the PCG is from about 1.4 g/cm³ and about 1.8 g/cm³. The PCG has a compressive strength of about 5 MPa to about 35 MPa.

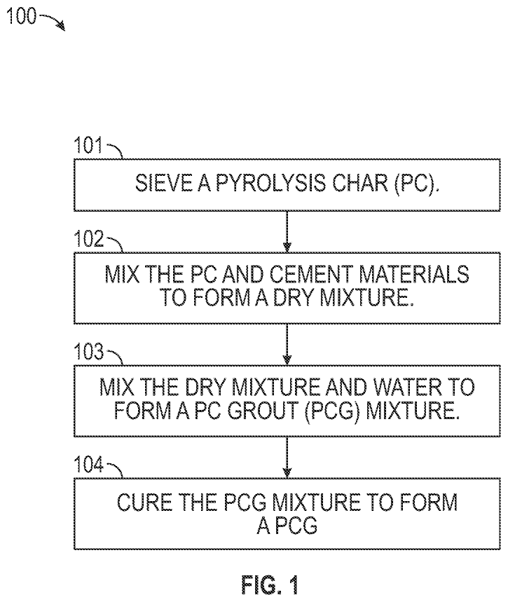

FIG. 1 illustrates a flow diagram illustrating a method 100 of forming a composition (e.g., a PCG composition). At operation 101, pyrolysis char (PC) is sieved.

At operation 102, the PC and cement materials are mixed to form a dry mixture. The PC is mixed with the cement materials using a mixer rotating at about 30 RPMs to about 100 RPMs, such as about 60 RPMs. The PC is mixed for about 1 minute to about 5 minutes, such as for about 3 minutes to form the dry mixture.

At operation 103, the dry mixture is mixed with water to form a PC grout (PCG) mixture. The dry mixture and water are mixed for about 1 minute to about 5 minutes, such as for about 3 minutes to form the PCG mixture.

At operation 104, the PCG mixture is cured to form a PCG. The PCG is cured at a temperature of about −25 °C and about 35 °C.

### Uses

Embodiments of the present disclosure also generally relate to uses of the compositions described herein. Compositions described herein can also be used for various applications.

Illustrative, but non-limiting, applications include pyrolysis char grout (PCG) for use in construction and building applications. Applications for PCG may also include carbon sequestration, among other renewable and “green” applications.

The following examples are put forth so as to provide those of ordinary skill in the art with a complete disclosure and description of how to make and use embodiments of the present disclosure, and are not intended to limit the scope of embodiments of the present disclosure. Efforts have been made to ensure accuracy with respect to numbers used but some experimental errors and deviations should be accounted for.

### Examples

### Test Methods

The PC is sieved using a Humboldt electric vibrating sieve machine for about 3 minutes.

The Marsh tunnel viscosity is measured using ASTM D6910 (2009). The Marsh viscosity is the flow time of 946 ml of grout material through a Marsh funnel to a graduated cylinder. The Marsh funnel has a capacity of 1500 ml and an internal orifice diameter of 4.75 mm. The Marsh funnel is cleaned and checked calibrated by measuring the viscosity of fresh water within a range of 26±0.5 seconds. The measurement of flow time is performed by plugging the internal orifice and pouring the grout material through a sieve that is provided at the top of the Marsh funnel. The internal orifice is unplugged and the grout material is allowed to flow out of the funnel into a graduated cylinder for a total of 946 ml. The flow time is measure. A longer flow time indicates a more viscous material.

The bleeding test is performed using ASTM C940 (2016). The grout material is poured into a 1000 ml graduated cylinder and mixed by rotating for 1 minute. The graduated cylinder is placed on a surface and the time measurement begins. The graduated cylinder is stopped with a stopper to avoid moisture loss, and the grout material is left for sedimentation. The initial volume is measured at the beginning of the time measurement. The volume observed at the upper surface of the water level (V₂) and volume at the upper surface of the grout material (V_{g}) are taken at 15 minute intervals for an hour, then at hour intervals until no successive readings show no additional bleeding or expansion. The bleeding water is decanted into another 100 ml graduated cylinder and the volume (V_{w}) is measured.

The setting time of the PCG is measured using the Vicat setting time test according to ASTM C191 (2018). The grout material is formed into a ball-like shape by tossing the grout material between hands at 150 mm apart for about three minutes. The grout material is placed into a cylindrical mold for the setting time test. The measurement of the setting time begins when the wet mixture is mixed with the dry mixture. The initial setting time is defined as the time duration between the first contact of the dry mixture and the wet mixture and when the 25 mm needle penetration value cannot be measured. If the 25 mm penetration value cannot be captured, interpolation is performed to determine the exact time at 25 mm penetration. The final setting time is obtained when the penetration needle can no longer leave a complete circular impression on the surface of the grout material.

The rheological testing is performed according to ASTM D4440 (2016). The rheology testing is performed using a strain controlled rheometer ARES G2. The water and dry mixture are mixed for 3 minutes to prepare the grout material. Using pipette, a grout material sample within a volume of 2 ml to 5 ml is placed on a bottom flat plate with a diameter of 50 mm. A top flat plate with a diameter of 50 mm is lowered to a gap ranging from 1.5 mm to 2.5 mm.

The Brunauer-Emmet-Teller (BET) specific surface area was measured according to ASTM D6556. The BET specific surface area was measured using QUADRASORB Evo Surface Area and Pore Size Analyzer.

The XRD was measured using Rigaku Smartlab using a CuKa radiation source.

The thermogravimetric analysis and differential thermal analysis were performed according to ASTM C1872. The thermogravimetric analysis and differential thermal analysis were measured using TA instrument Q500 equipment. During the TG/DT test, the temperature was increased from room temperature to 900 °C with a ramp rate of 10 °C/min and an inert gas (argon) environment with flow rate of 50 mL/min., operated at 40 kV and 40 mA with an angle of reflection (20) varied between 5° and 60°.

SEM was performed using FEI Quanta 250 SEM.

Bound water is measured according to ASTM C1897.

Heat of Hydration was measured using ASTM C1702. Heat of Hydration was measured using I-Cal 8000 HPC by Calmetrix. Deionized water was placed in the calorimeter within plastic containers, kept at a constant ambient temperature (23 °C) for 24 hours. Once the system has reached equilibrium, the dry mixture was mixed with deionized water to form the PCG mixture using a spoon for 30 seconds. The PCG mixture was then put into the calorimeter.

The compressive strength is measured using a Forney testing machine. The compressive strength of the PCG is measured using ASTM C109.

Thermal conductivity is measured using Hot Disk TPS 1500. The thermal conductivity of the PCGs was measured using ISO 22007-2.

### Experimental

Table 1 is a summary of the mixture designs for cement grout and pyrolysis char grout (PCG). The pyrolysis char (PC) is produced from Powder River Basin coal in Wyoming pyrolyzed at a temperature of 850 °C. The PC is sieved into two groups according to particle size: 1) <300 μm; and 2) 300 μm to 850 μm. The PC is mixed with the cement materials using a mixer rotating at about 60 RPMs for about 3 minutes to form the dry mixture. Water is added to the dry mixture to form the PCG mixture according to the mixture design and mixed for about 3 minutes.

The cement grout samples include a cement grout sample having a water/cement (w/c) ratio of 0.4, a cement grout sample having a w/c ratio of 0.8, a cement grout sample having a w/c ratio of 1.0, and a cement grout sample having a w/c ratio of 1.2. The PCG samples are varied from 0.4 w/c ratio to 1.2 w/c ratio and from 10% PC to 50% PC.

The PCG samples include a PCG sample having a particle size less than 300 μm, a water to cement ratio of 0.4, and a PC content of 10% (PCG/300/0.4/10), a PCG sample having a particle size less than 300 μm, a water to cement ratio of 0.8, and a PC content of 10% (PCG/300/0.8/10), a PCG sample having a particle size less than 300 μm, a water to cement ratio of 1.0, and a PC content of 10% (PCG/300/1.0/10), a PCG sample having a particle size less than 300 μm, a water to cement ratio of 1.2, and a PC content of 10% (PCG/300/1.2/10), a PCG sample having a particle size less than 300 μm, a water to cement ratio of 0.4, and a PC content of 20% (PCG/300/0.4/20), a PCG sample having a particle size less than 300 μm, a water to cement ratio of 0.8, and a PC content of 20% (PCG/300/0.8/20), a PCG sample having a particle size less than 300 μm, a water to cement ratio of 1.0, and a PC content of 20% (PCG/300/1.0/20), a PCG sample having a particle size less than 300 μm, a water to cement ratio of 1.2, and a PC content of 20% (PCG/300/1.2/20), a PCG sample having a particle size less than 300 μm, a water to cement ratio of 0.4, and a PC content of 30% (PCG/300/0.4/30), a PCG sample having a particle size less than 300 μm, a water to cement ratio of 0.8, and a PC content of 30% (PCG/300/0.8/30), a PCG sample having a particle size less than 300 μm, a water to cement ratio of 1.0, and a PC content of 30% (PCG/300/1.0/30), a PCG sample having a particle size less than 300 μm, a water to cement ratio of 1.2 and a PC content of 30% (PCG/300/1.2/30), a PCG sample having a particle size less than 300 μm, a water to cement ratio of 1.2, and a PC content of 40% (PCG/300/1.2/40), a PCG sample having a particle size less than 300 μm, a water to cement ratio of 1.2, and a PC content of 50% (PCG/300/1.2/50), a PCG sample having a particle from 300 μm to 850 μm, a water to cement ratio of 0.4, and a PC content of 10% (PCG/850/0.4/10), a PCG sample having a particle from 300 μm to 850 μm, a water to cement ratio of 0.8, and a PC content of 10% (PCG/850/0.8/10), a PCG sample having a particle from 300 μm to 850 μm, a water to cement ratio of 1.0, and a PC content of 10% (PCG/850/1.0/10), a PCG sample having a particle from 300 μm to 850 μm, a water to cement ratio of 1.2, and a PC content of 10% (PCG/850/1.2/10), a PCG sample having a particle from 300 μm to 850 μm, a water to cement ratio of 0.4, and a PC content of 20% (PCG/850/0.4/20), a PCG sample having a particle from 300 μm to 850 μm, a water to cement ratio of 0.8, and a PC content of 20% (PCG/850/0.80/20), a PCG sample having a particle from 300 μm to 850 μm, a water to cement ratio of 1.0, and a PC content of 20% (PCG/850/1.0/20), a PCG sample having a particle from 300 μm to 850 μm, a water to cement ratio of 1.2, and a PC content of 20% (PCG/850/1.2/20), a PCG sample having a particle from 300 μm to 850 μm, a water to cement ratio of 0.4, and a PC content of 30% (PCG/850/0.4/30), a PCG sample having a particle from 300 μm to 850 μm, a water to cement ratio of 0.8, and a PC content of 30% (PCG/850/0.8/30), a PCG sample having a particle from 300 μm to 850 μm, a water to cement ratio of 1.0, and a PC content of 30% (PCG/850/1.0/30), a PCG sample having a particle from 300 μm to 850 μm, a water to cement ratio of 1.2, and a PC content of 30% (PCG/850/1.2/30), a PCG sample having a particle from 300 μm to 850 μm, a water to cement ratio of 1.0, and a PC content of 40% (PCG/850/1.2/40), and a PCG sample having a particle from 300 μm to 850 μm, a water to cement ratio of 1.2, and a PC content of 50% (PCG/850/1.2/50).

TABLE 1
Summary of Mixture Designs for Cement Grout and PCG.

| | Char particle | Water/cement (w/c) | |
|---|---|---|---|
| Grout type | size (μm) | ratio | PC content (%) |
| Cement grout | — | 0.4, 0.8, 1.0, 1.2 | 0 |
| Char-cement | <300 | 0.4, 0.8, 1.0, 1.2 | 10, 20, 30 |
| grout | | 1.2 | 40, 50 |
| | 300-850 | 0.4, 0.8, 1.0, 1.2 | 10, 20, 30 |
| | | 1.2 | 40, 50 |

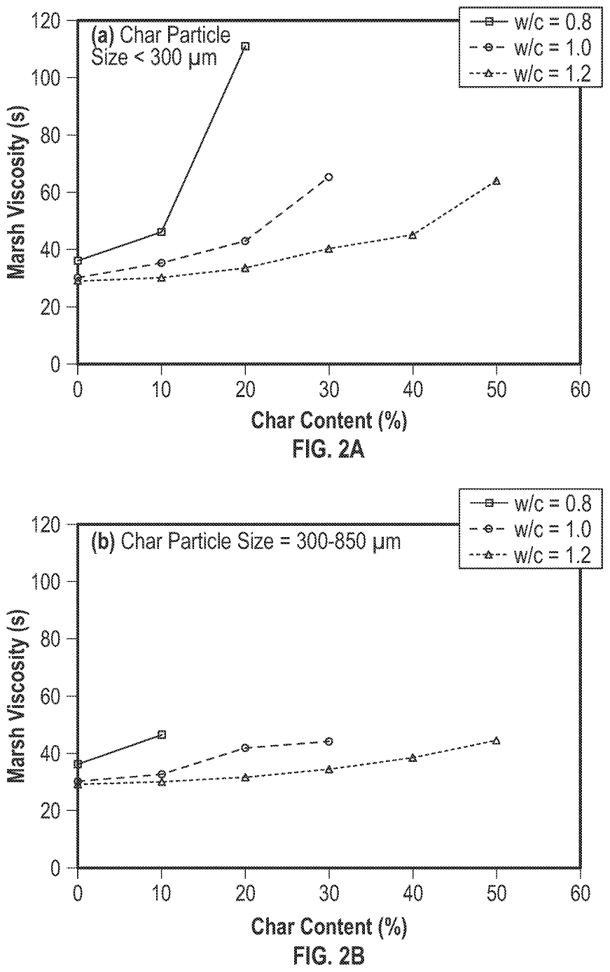

FIG. 2A is a graph illustrating Marsh viscosity versus PC content of PCG samples having a PC particle size of less than 300 μm. FIG. 2A is a graph illustrating Marsh viscosity versus PC content of PCG samples having a PC particle size from 300 μm to 850 μm. As PC content increases, the marsh viscosity increases. This may be due to the rougher surface of the PC due to its intrinsic porous structure compared to that of cement materials.

For PCG with PC particle size less than 300 μm, a relatively high viscosity is observed when the PCG/300/0.8/20 sample, the PCG/300/1.0/30 samples, and the PCG/300/1.2/50 sample. The PCG samples with a PC particle size from 300 μm to 850 μm, the viscosity gradually increases with increasing PC content. As the w/c ratio increases, however, the viscosity decreases.

The viscosity of the PCG having a PC particles size less than 300 μm is up to 48% greater than that of PCG having a PC particle size from 300 μm to 850 μm. This may be due to 1) the increase in the number of PC particles per unit volume, which may increase the degree of interaction among the particles when the particles have sub-micron sizes; and/or 2) the augmentation of hydrodynamic size of the PC particles due to hydration, surface charge, or adsorption layers.

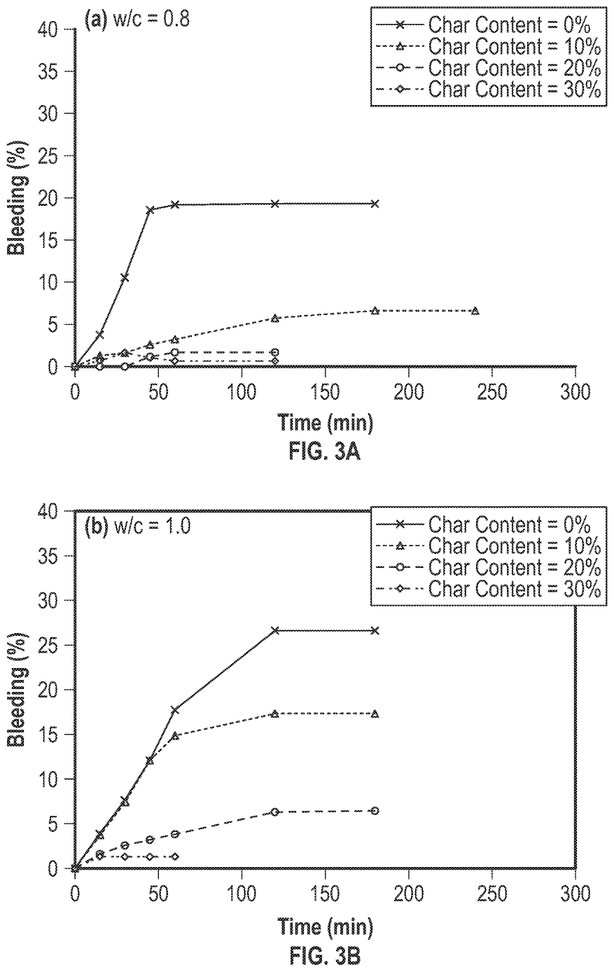

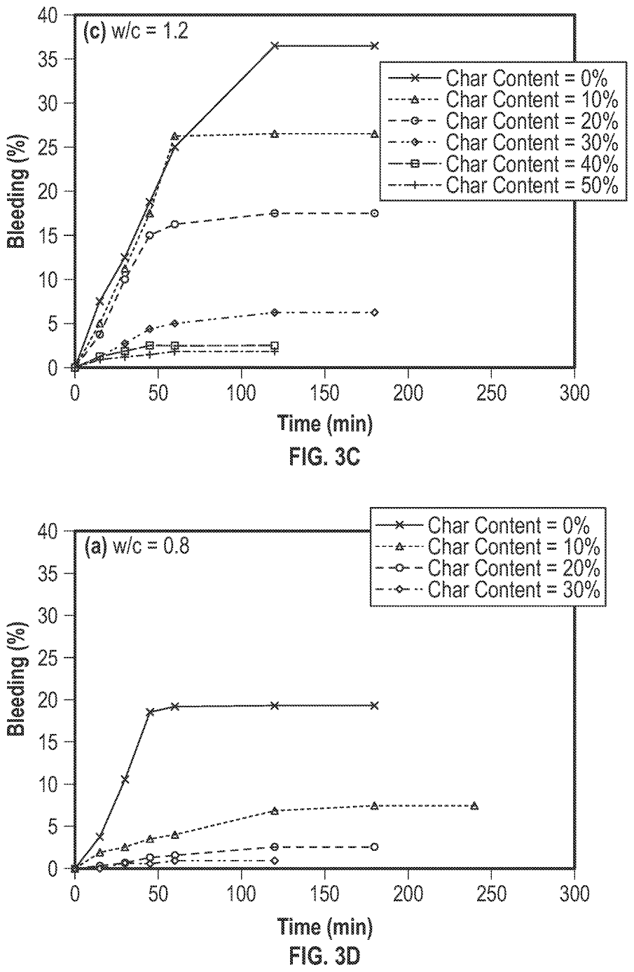

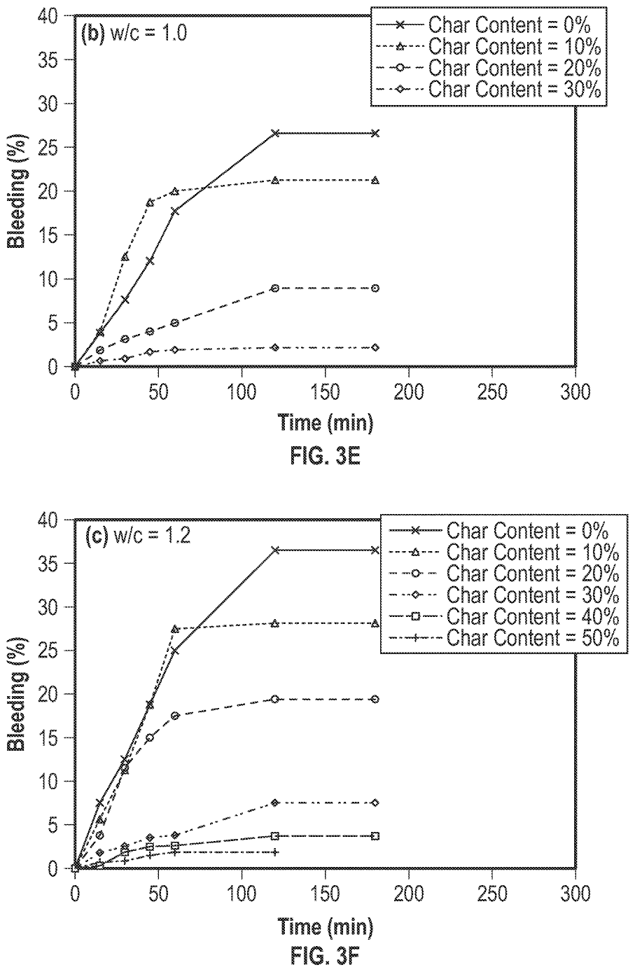

FIG. 3A is a graph illustrating the bleeding percentage versus time of PCG samples having a w/c ratio of 0.8 and a PC particle size of less than 300 μm. FIG. 3B is a graph illustrating the bleeding percentage versus time of PCG samples having a w/c ratio of 1.0 and a PC particle size of less than 300 μm. FIG. 3C is a graph illustrating the bleeding percentage versus time of PCG samples having a w/c ratio of 1.2 and a PC particle size of less than 300 μm. FIG. 3D is a graph illustrating the bleeding percentage versus time of PCG samples having a w/c ratio of 0.8 and a PC particle size of 300 μm to 850 μm. FIG. 3E is a graph illustrating the bleeding percentage versus time of PCG samples having a w/c ratio of 1.0 and a PC particle size of 300 μm to 850 μm. FIG. 3F is a graph illustrating the bleeding percentage versus time of PCG samples having a w/c ratio of 1.2 and a PC particle size of 300 μm to 850 μm. The bleeding percentage is calculated using Equation (1):

$$Bleeding \% = \frac{100 \times ( {V}_{2} - {V}_{g} )}{{V}_{1}} \qquad ( 1 )$$

Where the V₁ is the initial volume of the PCG, V₂ is the upper surface of the water level, and V_{g} is the upper surface of the volume of the PCG. The bleeding percentage increased as the w/c ratio increases. Bleeding percentage significantly decreases with increasing PC content. This may be due to the water absorbing capacity of the porous PC particles.

The bleeding percentage increased up to 31% as the particle size of the PC increase. This may be due to: 1) the bonding force between smaller PC particles is greater, consolidation of smaller PC particles is less, and the smaller particles can store more water in the micropores, which may lead to lower bleeding; 2) larger PC particle sizes settle down quicker and consolidate easier than smaller particles. This may cause a decrease in the porosity of PCG, making more water available for bleeding; and/or 3) a narrow particle range distribution reduces the tendency of the PC particle to agglomerate. Lower agglomeration enables water to be held in the pore spaced pf the PC rather than be available for lubricating particles. The particle size distribution of PC with a PC particle size of 300 μm to 850 μm is greater than the PC having a particle size lower than 300 μm, which may cause higher bleeding in the PCG with a PC particle size of 300 μm to 850 μm.

The expansion percentage of the PCG is calculated using Equation (2):

$$Expansion \% = \frac{100 \times ( {V}_{g} - {V}_{1} )}{{V}_{1}} \qquad ( 2 )$$

A high expansion percentage may cause undesirable engineering issues (e.g., cracks) in the PCGs.

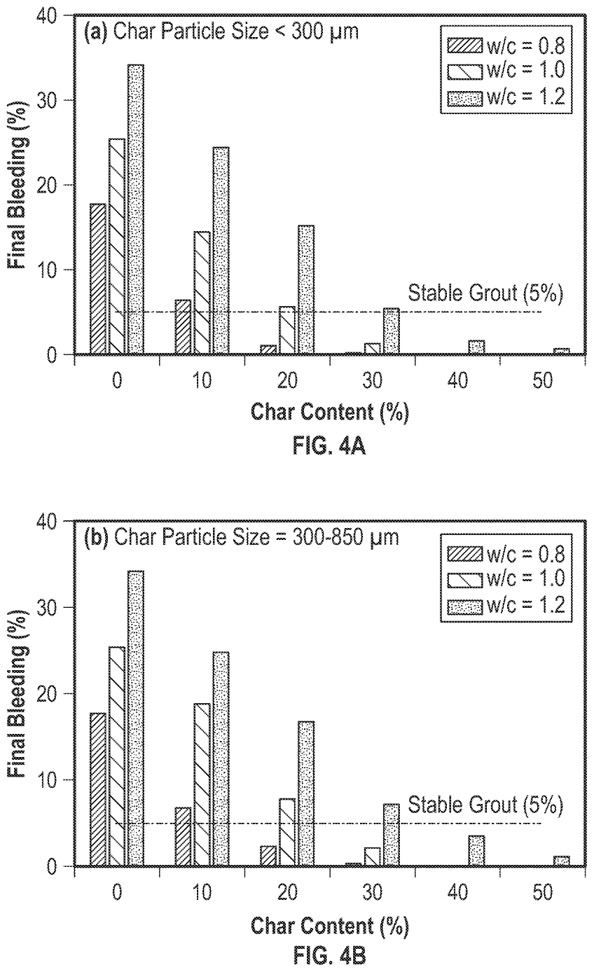

FIG. 4A is a graph illustrating the final bleeding percentage of PCG samples having a PC particle size of less than 300 μm. FIG. 4B is a graph illustrating the bleeding percentage versus time of PCG samples having a PC particle size of 300 μm to 850 μm. The bleeding percentage is calculated using Equation (3):

$$Final Bleeding \% = \frac{100 \times ( {V}_{w} )}{{V}_{1}} \qquad ( 3 )$$

Where V_{w} is the final volume of water separated from the PCG. According to ASTM C940 (2016), grout material is considered stable is final bleeding is less than 5%. As PC content increases, the final bleeding percentage decreased. As the w/c ratio increases, however, the final bleeding percentage increases. For both PC particles sizes, the 0.8 w/c ratio and 20% or higher PC content samples met the ASTM standard for stability (e.g., the PCG/300/0.8/20 sample, the PCG/300/0.8/30 sample, the PCG/850/0.8/20 sample, and the PCG/850/0.8/30 sample). For both PC particle sizes, the 1.0 w/c ratio and 30% or higher PC content samples met the ASTM standard for stability (e.g., the PCG/300/1.0/30 sample and the PCG/850/1.0/30 sample). For both PC particle sizes, the 1.2 w/c ratio and 40% or higher PC content samples met the ASTM standard for stability (e.g., the PCG/300/1.2/40 sample, PCG/300/1.2/50 sample, PCG/850/1.2/40 sample, and the PCG/850/1.2/50 sample).

Table 2 is a summary of the initial and final setting times for cement grout and PCG.

TABLE 2
Initial and Final Setting Times for Cement Grout and PCG.

| | | | | Initial | Final |
|---|---|---|---|---|---|
| | Char | Char | Water/cement | setting | setting |
| | particle | content | (w/c) | time | time |
| Grout type | size (μm) | (%) | ratio | (min) | (min) |
| Cement grout | — | 0 | 0.4 | 220 | 436 |
| Char-cement | <300 | 10 | 0.4 | 136 | 330 |
| grout | | 20 | 0.4 | 39 | 300 |
| | | 30 | 0.5^{a} | 80 | 270 |
| | 300-850 | 10 | 0.4 | 226 | 345 |
| | | 20 | 0.4 | 103 | 295 |
| | | 30 | 0.4 | 20 | 195 |

Both the initial and final setting time of PCG decrease with increasing PC content. This may be due to the strong water absorption of the porous PC particles. For the same PC content, the initial setting time for PCG having a PC particle size of less than 300 μm is lower than that of PCG having a PC particle size of 300 μm to 850 μm. However, the effect of PC particle size on final setting time is relatively similar when the PC content is lower than 30%. At 30% PC, the PCG with a PC particle size of 300 μm to 850 μm has a lower initial and final setting time than PCG with a PC particle size less than 300 μm.

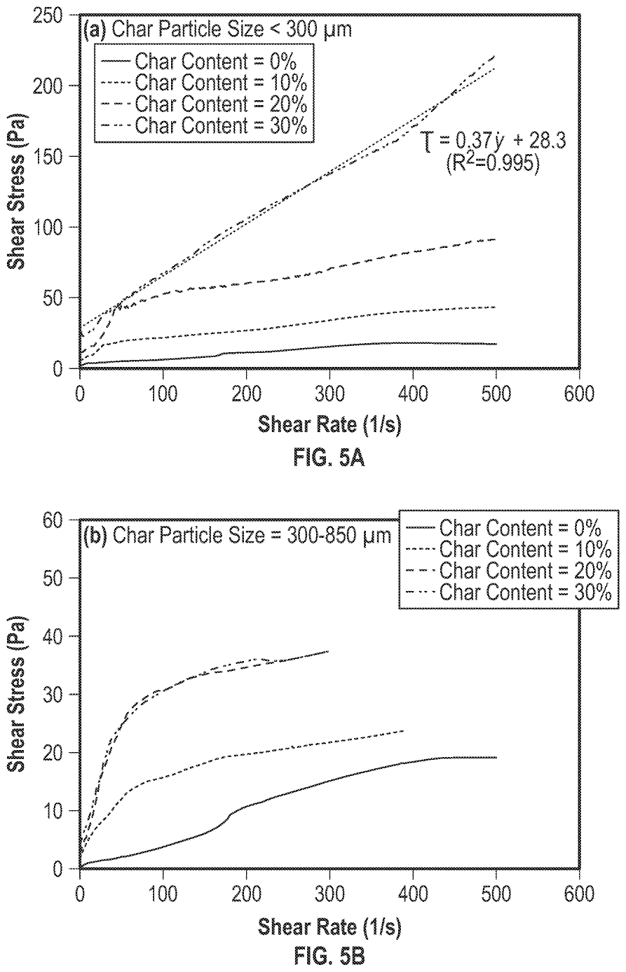

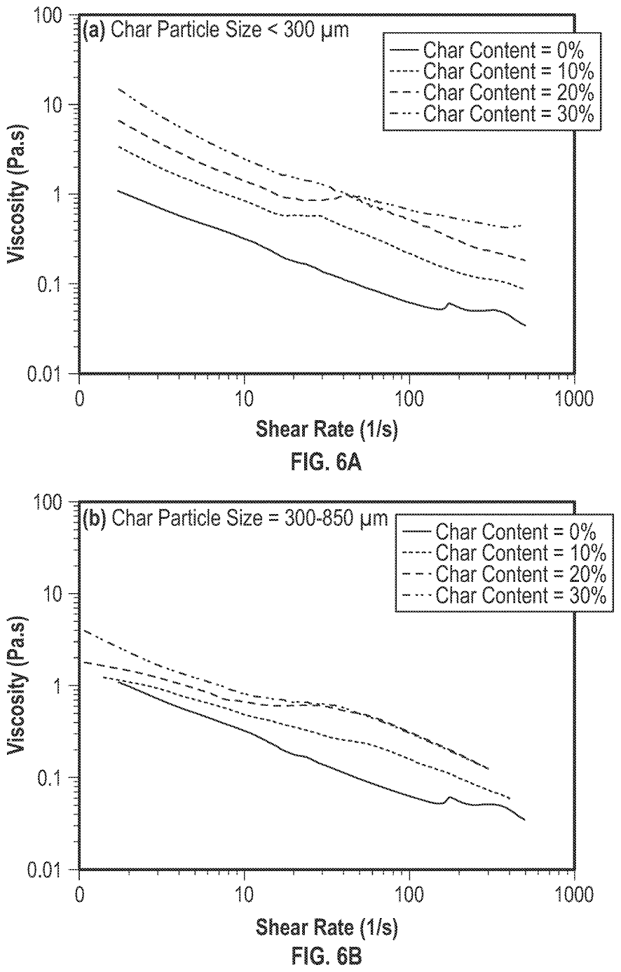

FIG. 5A is a graph illustrating the shear stress-shear rate relationship of PCG having a w/c ratio of 0.8 and a PC particle size of less than 300 μm. FIG. 5B is a graph illustrating the shear stress-shear rate relationship of PCG having a w/c ratio of 0.8 and a PC particle size of 300 μm to 850 μm. FIG. 6A is a graph illustrating the viscosity-shear rate relationship of PCG having a w/c ratio of 0.8 and a PC particle size of less than 300 μm. FIG. 6B is a graph illustrating the viscosity-shear rate relationship of PCG having a w/c ratio of 0.8 and a PC particle size of 300 μm to 850 μm. The viscosity is calculated according to Equation (4):

$$μ = \frac{τ}{\dot{γ}} \qquad ( 4 )$$

Where μ is viscosity, t is shear stress, and \dot{γ} is shear rate. An increase in the PC content increases the shear stress of the PCG at a fixed shear rate. At the same shear rate and PC content, the shear stress of the PCG with a PC particle size less than 300 μm is up to 5 times higher than that of PCG with a PC particle size of 300 μm to 850 μm (e.g., the PCG with a PC particle size less than 300 μm has a higher viscosity).

Regardless of PC particle size, the shear stress-shear rate relationship exhibits shear-thinning behaviors, e.g., viscosity decreases as shear rate monotonically increases. This behavior is calculated using the Bingham Model of Equation (5):

τ=τ_{y}+μₚ\dot{γ} (5)

Where τ_{y} is the yield shear and μₚ is the plastic viscosity. The PCG samples with a w/c ratio of 0.8 and a char content of 30% (PCG/300/0.8/30) has a yield shear stress and plastic viscosity of PCG are 28.3 Pa and 0.37 Pa, respectively. This behavior approximates Bingham plastic behavior, with the shear stress-shear rate relationship of R²=0.995.

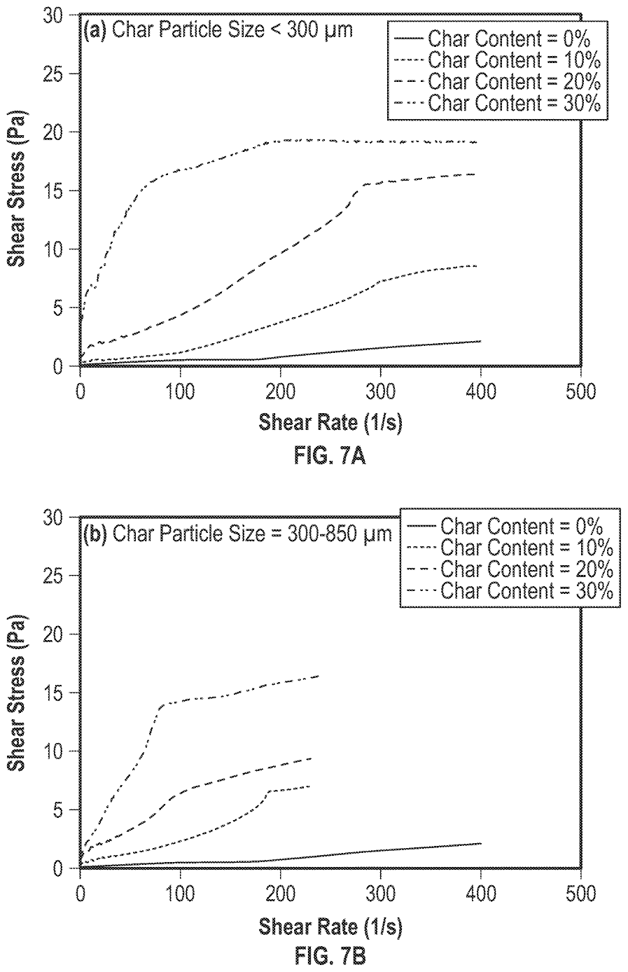

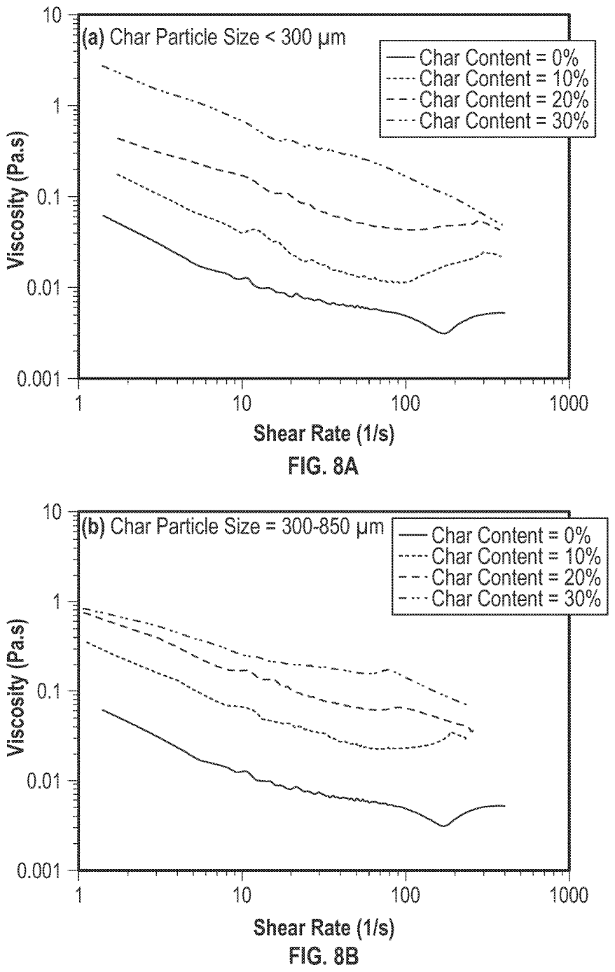

FIG. 7A is a graph illustrating the shear stress-shear rate relationship of PCG having a w/c ratio of 1.0 and a PC particle size of less than 300 μm. FIG. 7B is a graph illustrating the shear stress-shear rate relationship of PCG having a w/c ratio of 1.0 and a PC particle size of 300 μm to 850 μm. FIG. 8A is a graph illustrating the viscosity-shear rate relationship of PCG having a w/c ratio of 1.0 and a PC particle size of less than 300 μm. FIG. 8B is a graph illustrating the viscosity-shear rate relationship of PCG having a w/c ratio of 1.0 and a PC particle size of 300 μm to 850 μm.

At the same shear rate and PC particle size, the shear stress of PCG with a w/c ratio of 1.0 is lower than that of PCG with a w/c ratio of 0.8. This may be due to the high water content in the PCG with a w/c ratio of 1.0. At the same shear rate and PC content, the shear stress of the PCG with a PC particle size of less than 300 μm is up to 5.5 times higher than that the PCG with a PC particle size of 300 μm to 850 μm. This is consistent with the results for the PCG samples with a w/c ratio of 0.8.

The PCG samples with a PC particle size of less than 300 μm and a PC content of 10% (PCG/300/1.0/10%), 20% (PCG/300/1.0/20%), and a PC particle size of 300 μm to 850 μm and a PC content of 10% (PCG/850/1.0/10%) exhibit shear-thinning and shear-thickening transition behaviors, as does the cement grout sample. The critical shear rate to differentiate the shear-thinning zone and the shear thickening zone can be identified from the viscosity-shear rate curves on a log-log scale as the lowest viscosity value. The critical shear rates of PCG with a PC particle size of less than 300 μm and a PC content of 10% (PCG/300/1.0/10%) and 20% (PCG/300/1.0/20%) are 98.4 S⁻¹ and 116.7 S⁻¹, respectively. The critical shear rate of PCG with a PC particle size of 300 μm to 850 μm and a PC content of 10% (PCG/850/1.0/10%) is 73.1 S⁻¹. By comparison, the cement grout has a critical shear rate of 170.7 S⁻¹. The critical shear rate may be used to differentiate the shear-thinning zone and shear-thickening zone. The critical shear rate of the viscosity-shear rate curves are in a log-scale and corresponds to the lowest viscosity. The critical shear rate of PCG is typically lower than that of cement grout.

No transition behavior was seen by the PCG samples having a PC particle size of less than 300 μm and a PC content of 30% (PCG/300/1.0/30%), a PC particle size of 300 μm to 850 μm and a PC content of 20% (PCG/850/1.0/20%), and a PC particle size of 300 μm to 850 μm and a PC content of 30% (PCG/850/1.0/30%).

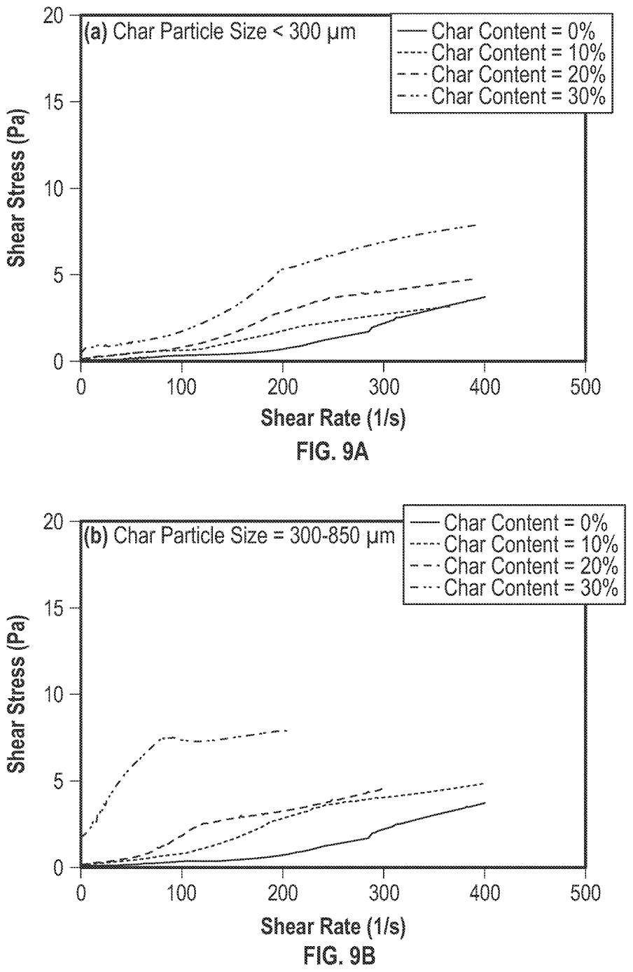

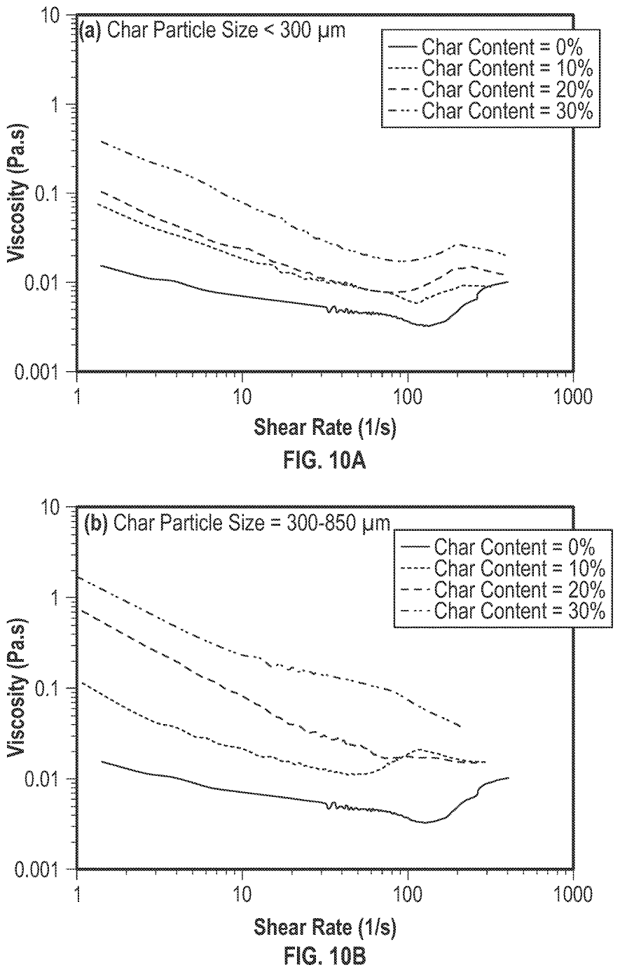

FIG. 9A is a graph illustrating the shear stress-shear rate relationship of PCG having a w/c ratio of 1.2 and a PC particle size of less than 300 μm. FIG. 9B is a graph illustrating the shear stress-shear rate relationship of PCG having a w/c ratio of 1.2 and a PC particle size of 300 μm to 850 μm. FIG. 10A is a graph illustrating the viscosity-shear rate relationship of PCG having a w/c ratio of 1.2 and a PC particle size of less than 300 μm. FIG. 10B is a graph illustrating the viscosity-shear rate relationship of PCG having a w/c ratio of 1.2 and a PC particle size of 300 μm to 850 μm.

At the same shear rate and PC particle size, the shear stress of PCG with a w/c ratio of 1.2 has the lowest shear stress. At the same shear rate and PC content, the shear stress of the PCG with a PC particle size of less than 300 μm is up to 1.8 times lower than that the PCG with a PC particle size of 300 μm to 850 μm. This trend differs from the PCG samples with w/c ratios of 0.8 and 1.0, which may be due to the porosity of the PCG with a PC particle size of less than 300 μm. With high specific surface area and high water holding capacity that decreases the available water for lubricating particles, the porosity of the PCG with a PC particle size of less than 300 μm may contribute to a higher shear stress in PCG.

The PCG samples with a PC particle size of less than 300 μm and a PC content of 10% (PCG/300/1.2/10%), 20% (PCG/300/1.2/20%), 30% (PCG/300/1.2/30%), and a PC particle size of 300 μm to 850 μm and a PC content of 10% (PCG/850/1.2/10%) exhibit shear-thinning and shear-thickening transition behaviors, as does the cement grout sample. The critical shear rates of PCG with a PC particle size of less than 300 μm and a PC content of 10% (PCG/300/1.2/10%), 20% (PCG/300/1.2/20%), and 30% (PCG/300/1.2/30%) are 112.8 S⁻¹, 76.1 S⁻¹, and 90.7 S⁻¹, respectively. The critical shear rate of PCG with a PC particle size of 300 μm to 850 μm and a PC content of 10% (PCG/850/1.2/10%) is 73.1 S⁻¹. By comparison, the cement grout has a critical shear rate of 132.1 S⁻¹.

No transition behavior was seen by the PCG samples having a PC particle size of 300 μm to 850 μm and a PC content of 20% (PCG/850/1.2/20%), and a PC particle size of 300 μm to 850 μm and a PC content of 30% (PCG/850/1.2/30%).

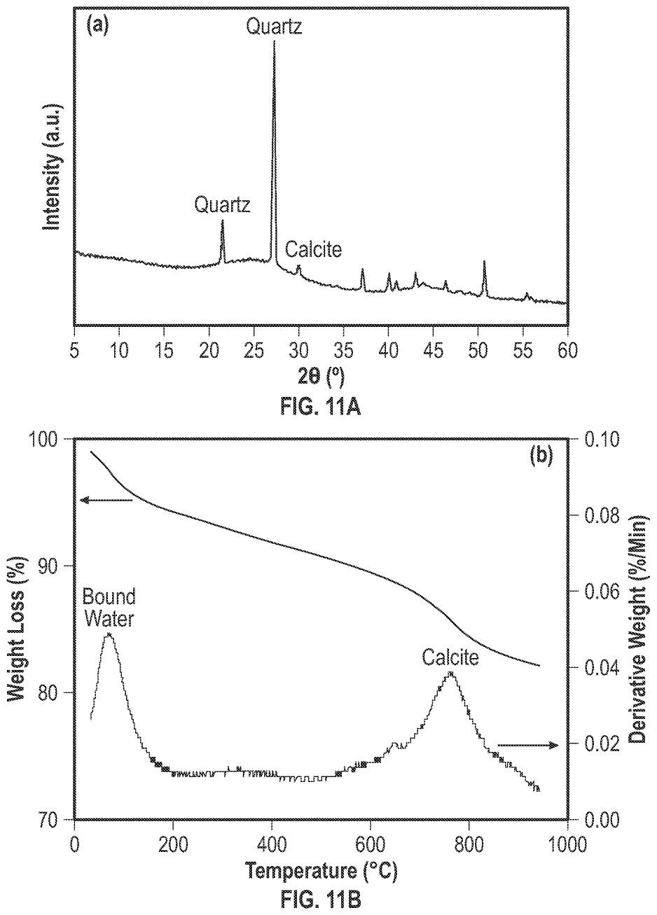

FIG. 11A is a graph illustrating the X-ray diffraction (XRD) of PC. FIG. 11B is a graph illustrating the thermogravimetric (TG) analysis and differential thermal (DT) analysis of PC. Characteristic peaks for quartz (~22° and) 27° and calcite (~29°) are observed in the PC. Two peaks in the DT curve indicate the loss of physically bound water (67.2 °C) and the decarbonation of calcite (762.2 °C). The PC has a Brunauer-Emmet-Teller (BET) specific surface area of 262 m²/g. The PC particle size distribution included: 99% of weight passes through the 850 μm sieve; 49.9% of weight passes through the 300 μm sieve; and 3.3% of weight passes through the 75 μm sieve. A Humboldt electric vibrating sieve machine further sieves the PC to a particle size of less than 300 μm.

PCG samples were made with three w/c ratios (0.8, 1.0, 1.2), four PC contents (0% (cement grout) 10%, 20%, 30%), and a PC particle size less than 300 μm. The PCG samples were tested at −25 °C (−25PCG), 5 °C (5PCG), 25 °C (25PCG), and 35 °C (35PCG) to test performance in different geographical regions and seasons. The cement materials and PC are weight and homogenously mixed for three minutes by using a laboratory mixer to form the dry mixture. The dry mixture was mixed with water to form the PCG mixture. The PCG mixture was transferred to molds of 50 mm³ in three equal layers, with tapping against a table 50 times per layer to remove trapped air bubbles. The molds are covered by a plastic membrane for initial curing of 48 hours at room temperature (~24 °C and relative humidity 40%). After an initial curing, the PCG samples are demolded and divided into groups based on testing temperatures. At sub-zero temperatures, the −25PCG samples were sealed in a plastic bag and stored in a freezer with digital temperature control. At above zero temperatures, the PCG samples were submerged in deionized water and stored in plastic containers. The 5PCG samples were stored in a freezer, the 25PCG were stored in a moisture room (relative humidity ≥95%), and the 35PCG samples were stored in an oven. All PCGs were cured until cure times of 7 days or 28 days.

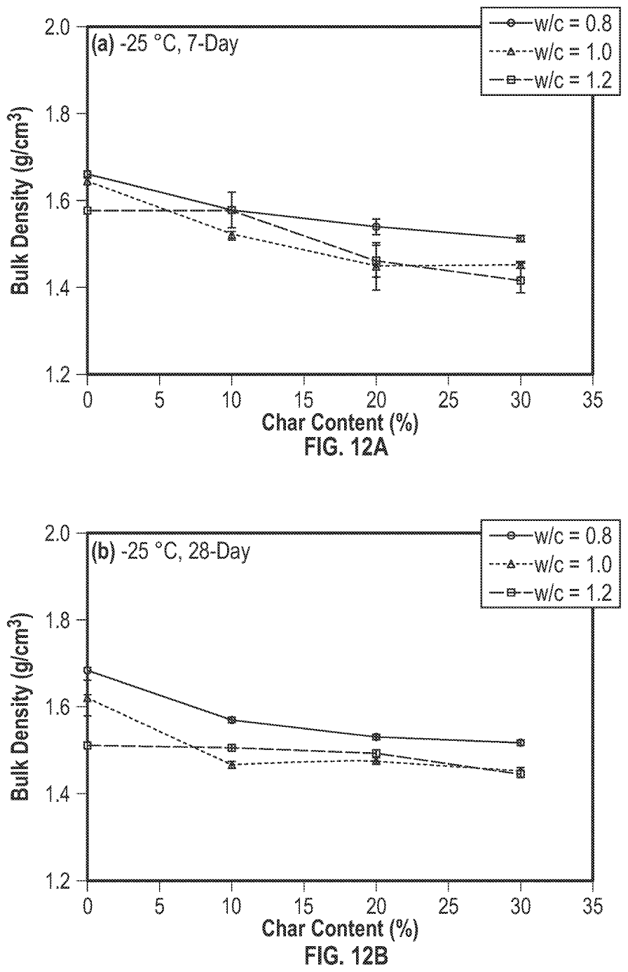

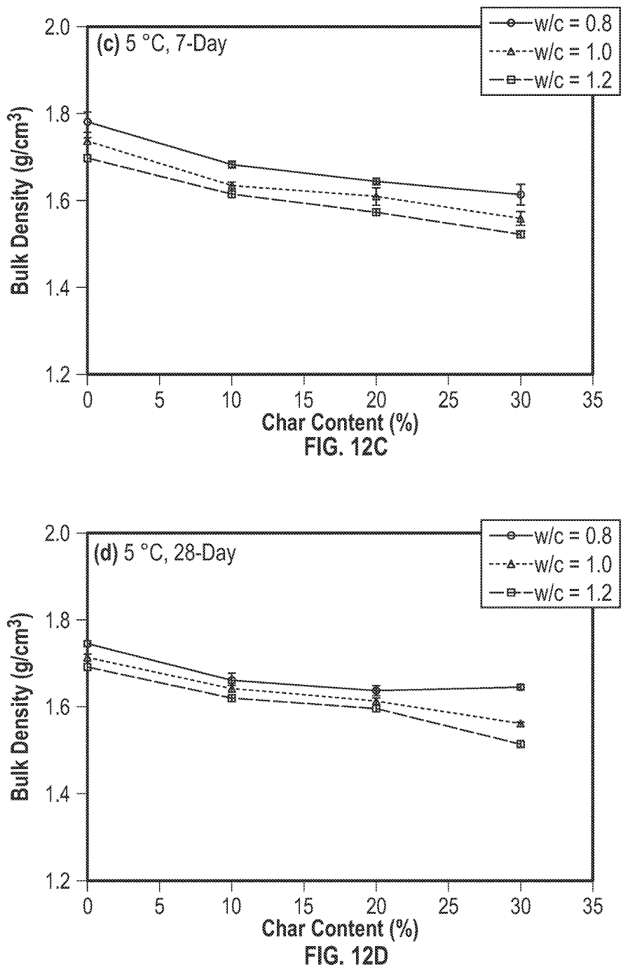

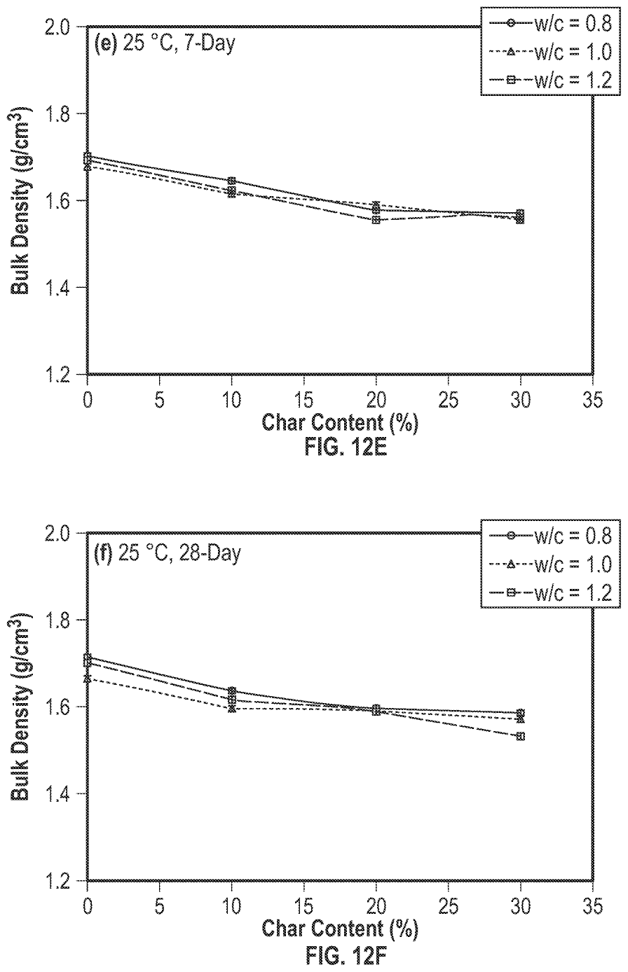

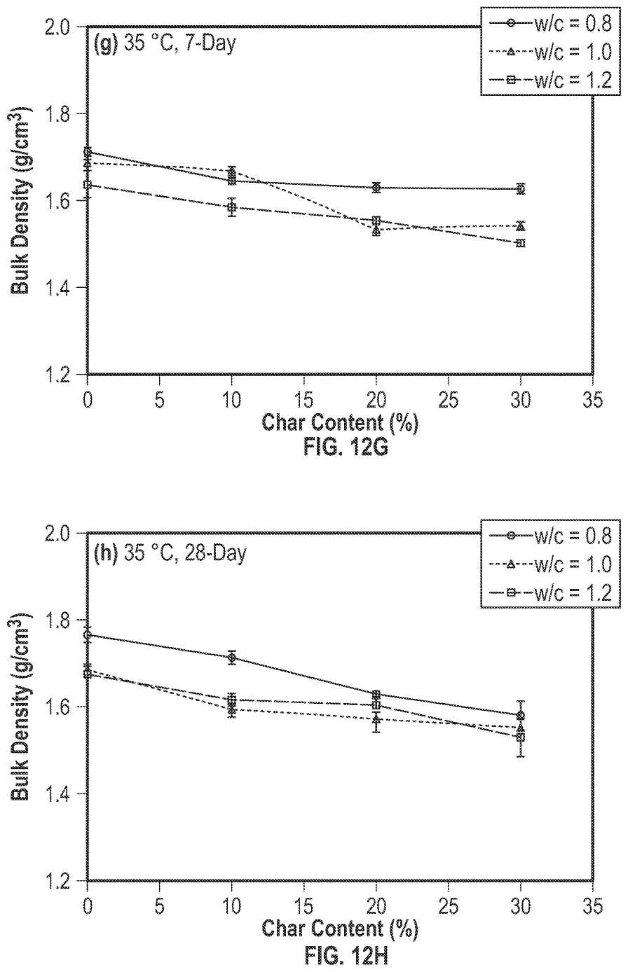

FIG. 12A is a graph illustrating the density versus PC content of a −25PCG sample with a 7 day cure (−25PCG/7 d). FIG. 12B is a graph illustrating the density versus PC content of a −25PCG sample with a 28 day cure (−25PCG/28 d). FIG. 12C is a graph illustrating the density versus PC content of a 5PCG sample with a 7 day cure (5PCG/7 d). FIG. 12D is a graph illustrating the density versus PC content of a 5PCG sample with a 7 day cure (5PCG/28 d). FIG. 12E is a graph illustrating the density versus PC content of a 25PCG sample with a 7 day cure (25PCG/7 d). FIG. 12F is a graph illustrating the density versus PC content of a 25PCG sample with a 7 day cure (25PCG/28 d). FIG. 12G is a graph illustrating the density versus PC content of a 35PCG sample with a 7 day cure 35PCG/7 d). FIG. 12H is a graph illustrating the density versus PC content of a 35PCG sample with a 7 day cure (35PCG/28 d).

As PC content increases, the density of the PCG decreases for PCG samples of all testing temperatures and curing times. This may be due to the low bulk density of PC compared to unhydrated cement materials and hydration products (C—S—H and ettringite) and the addition of the porous PC may lead to an increase in porosity of the PCG. The density of the cement grout cured at −25 °C for 7 days was 1.4% less, 4.3% more, and 4.2% more than the cement grout cured at −25 °C for 28 days for the w/c ratios of 0.8, 1.0, and 1.2, respectively. The bulk density may be influenced by the volumetric change of grouts prepared with varying w/c ratios. The axial strain change of hardened cement paste at subzero temperatures may indicate that the cement grout samples contract linearly as temperature decreases until reaching the ice nucleation point. After the ice nucleation point, the cement grout begins to expand until achieving the lowest subzero temperature. The ice nucleation point may be affected by air content, hydraulic and osmotic pressure, and ice crystal saturation. The ice nucleation point is about −15 °C, which may lead to the cement grout experiencing both volumetric shrinkage and expansion when decreasing in temperature. The decrease in the density of the cement grout having a w/c ratio of 0.8 may be due to the formation of less ice. A large amount of ice may form in saturated void spaces due to a higher w/c ratio, leading to an increase in pore pressure, contributing to the expansion of cement grout with a w/c ratio of 1.0 and 1.2.

The density of PCG that is cured for 28 days is lower than the PCG cured for 7 days at the same w/c ratio by about 0.3% to about 0.6%. It is believed that PCG enables ice crystals to fill the porous space of the PC. This may enable the pore pressure caused by ice formation to be reduced without leading to significant expansion. As the temperature decreases from −1 °C to −20 °C, the minimum pore size that the ice crystal can penetrate into decreases from 68 nm to 4.5 nm in cement materials, leading to less reduction in the pre pressure.

At the same curing time, the PCG at 5 °C is 7.0-7.9% higher than that of PCG at −25 °C. At the same curing time, the PCG at 25 °C is 5.3-5.4% higher than that of PCG at −25 °C. At the same curing time, the PCG at 35 °C is 5.1-6.4% higher than that of PCG at −25 °C. These results may be due to water absorption in the PCG at elevated temperatures.

At a fixed w/c ratio, for temperatures of 5 °C, 25 °C, and 35 °C, the density of cement grout cured for 28 days decreased 0.2-2.0%, −0.8-0.8%, and 0.8-3.2%, respectively, compared to cement grouts cured for 7 days. At a fixed w/c ratio, for temperatures of 5 °C, 25 °C, and 35 °C, the density of PCG cured for 28 days increased 0.1-0.5%, 0-0.4%, and 0.8-4.7%, respectively, compared to PCG cured for 7 days. The change in density of cement grouts is greater than PCG at the same temperatures. The cement grouts with w/c ratios of 0.8 and 1.0 decrease from a 7 day cure to a 28 day cure, while PCGs increase regardless of the w/c ratio and temperature. Cement grouts having a relatively low w/c ratio≤1.0. The decreasing trend in density of cement grouts may due to the volumetric expansion of cement grouts due to the formation of hydration products, especially ettringite. The expansion rate of cement grout can increase 0.1% to 0.4% with an increased curing time. For PCG, the consistent increase in density is due to a lower volumetric expansion, since the formation of ettringite can be filled into the porous structures in the PC particles. Further, the increase of weight due to absorbing more water is increased because of the high capillary force and water holding capacity of the porous PC. At a fixed PC content, the effect of the w/c ratio on the density of 5PCG samples and 35 PCG samples is less significant. This may be due to the formation of crystalline hydration products (ettringite and portlandite) at 5 °C and 35 °C, which tend to cause the volumetric expansion of PCG, compared to the formation of more amorphous hydration products (e.g., C—S—H gel) formed at 25 °C, which may lead to less volumetric change.

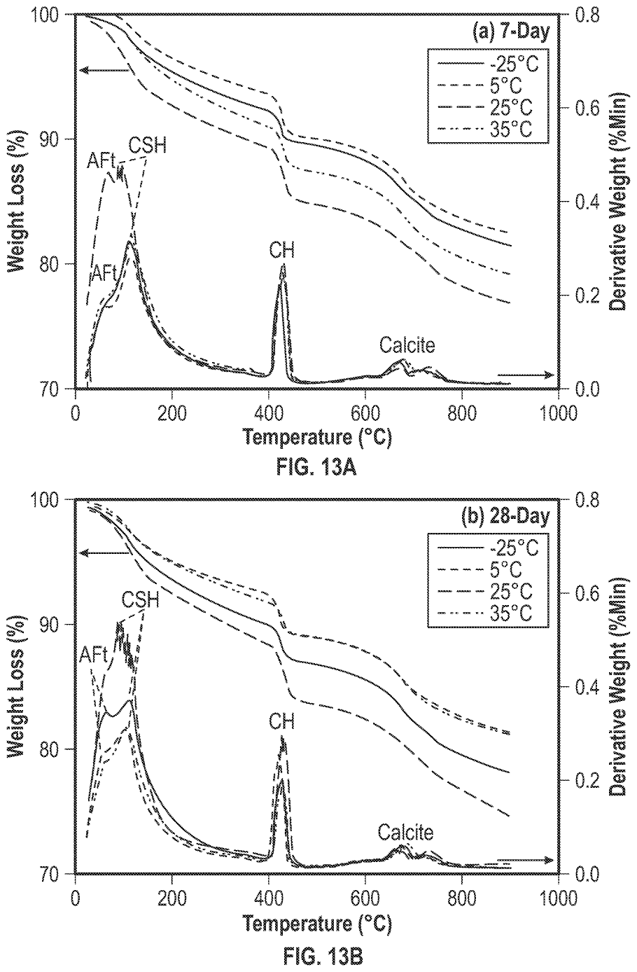

FIG. 13A is a graph illustrating the thermogravimetric (TG) analysis and differential thermal (DT) analysis of PCG samples cured for 7 days. FIG. 13B is a graph illustrating the TG analysis and DT analysis of PCG samples cured for 28 days. Three main peaks are observed in the DT curve for: 1) the loss of physically bound water in the PC and chemically bound water in the cement hydration products (e.g., ettringite and C—S—H) at 60 °C to 350 °C; 2) dehydroxylation of portlandite (CH) at 400 °C to 500 °C; and 3) decarbonation of calcite at 600 °C to 800 °C. At the same curing time, the largest initial weight loss (due to dehydration) of PCG is observed at 25 °C. The largest initial weight loss may be due the largest formation of hydration products. At the decarbonation temperature of 600 °C to 800 °C, the DT curve of PCG shows a two-step decomposition peak, as compared the one-step decomposition peak of PC, at all curing times and temperatures. This may be due to the higher amount of CO₂ from carboaluminates formed during hydration due to the pre-existing calcium carbonate in PC.

At 7 days of curing, the PCGs at −25 °C and 5 °C have less initial weight loss. This may be due to the hydration reaction being retarded at low temperatures, leading to relatively less hydration products formed. The initial weight loss of PCGs at 35 °C is less than that of PCGs at 25 °C. This may be due to increasing temperatures causing a decrease in C—S—H bound water contents. The first peak of the DT curve corresponding to the dehydration temperatures shows two subtle peaks at 60 to 70 °C and 100 °C to 125 °C, for all PCGs cured for 7 days. These peaks may be attributed to the dehydration of ettringite (Aft phase) and C—S—H gel, respectively. Ettringite has relatively low thermal stability and loses bound water at a temperature of ≤70 °C, while C—S—H gel is generally higher than 100.

At 28 days of curing, the weight loss of PCGs at −25 °C is higher than that of PCGs at 5 °C and 35 °C. This may be due to: 1) cement hydration continuing at a subzero temperature until non-freezable water is consumed. To fully arrest the cement hydration, a very low temperature (e.g., less than −60 °C) is necessary. The addition of PC can increase the content of physically bound water to the PCG mixture due to the PC having a large specific surface are. The bound water can remain in liquid form at subzero temperatures. When a PCG is cured at subzero temperatures, the PC can gradually release the bound water through hydraulic and osmotic pressures and facilitate the hydration reaction; 2) a weight loss of the PCG cured at 5 °C or 35 °C at dehydration temperatures may be caused by C—S—H carbonation. When reacting with CO₂, the C—S—H can be decomposed and form calcite and silica gel. CO₂ solubility in water at 5 °C is 110% higher than at 25 °C at atmospheric pressure, which may contribute to the decomposition of C—S—H and hence causing less change in weight loss of PCG cured at 5 °C. For PCG cured at 35 °C, a high temperature (generally less than 150 °C) may enable an acceleration of the carbonation rate and hence the decomposition of C—S—H.

Table 3 summarizes the contents of physically and chemically bound water, portlandite, and calcite in PC and PCG with a PC content of 20%. The bound water and calcite contents of PC are 5.5% and 11.6%, respectively. The compositions in the dry mixture are predominantly from the PC, thus, the pre-existed bound water and calcite in the dry mixture can be calculated as 0.9% and 1.9%, respectively. Compared to the dry mixture, all PCG cured at different temperatures have higher bound water and calcite contents, which may be due to cement hydration and carbonation of hydration products in the PCG. At the curing time increases from 7 days to 28 days, the bound water contents of PCGs cured at −25 °C and 25 °C increased 23% and 9%, respectively. This may be beneficial for increasing the strength performance of PCG. For PCG cured at 5 °C and 35 °C, the bound water content either stayed constant or decreased 10 percent, respectively. This may be due to the C—S—H carbonation. For PCG cured at 5 °C and 35 °C, when compared to PCG cured at 25 °C, calcite content decreases with increasing curing times.

TABLE 3
Summary of Contents of Physically and Chemically Bound Water,
Portlandite, and Calcite in PC and PCG with 20% PC.

| | Dry | −25 °C | | 5 °C | | 25 °C | | 35 °C | |
|---|---|---|---|---|---|---|---|---|---|
| Composition | mixture | 7 d | 28 d | 7 d | 28 d | 7 d | 28 d | 7 d | 28 d |
| Bound water (%) | 0.9 | 6.6 | 8.1 | 6.1 | 6.1 | 8.6 | 9.4 | 7.7 | 6.9 |
| Portlandite (%) | n/a | 11.5 | 13.2 | 14.7 | 14.0 | 18.5 | 20.1 | 14.8 | 11.7 |
| Calcite (%) | 1.9 | 12.3 | 13.5 | 12.0 | 11.8 | 12.2 | 12.9 | 12.9 | 12.4 |

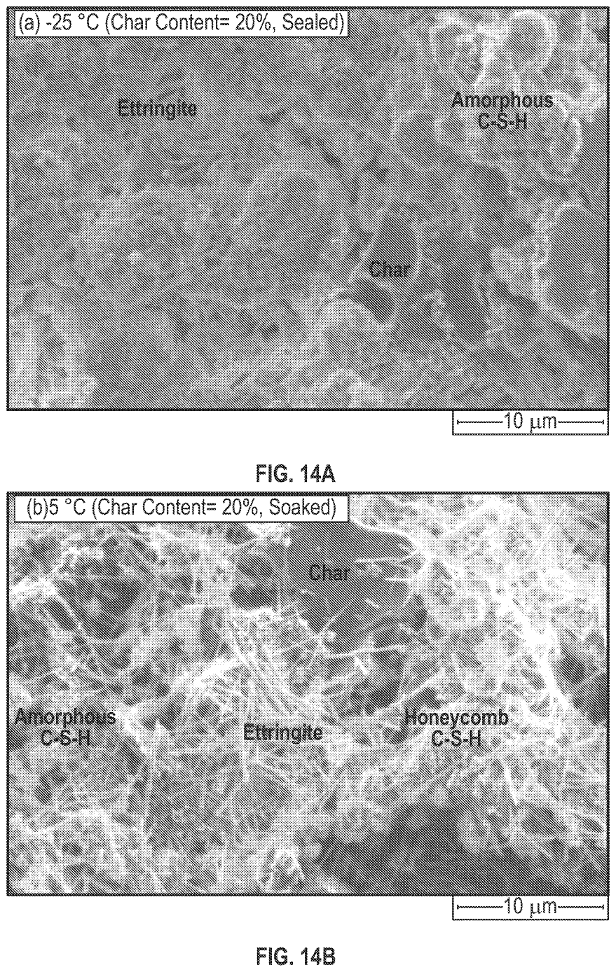

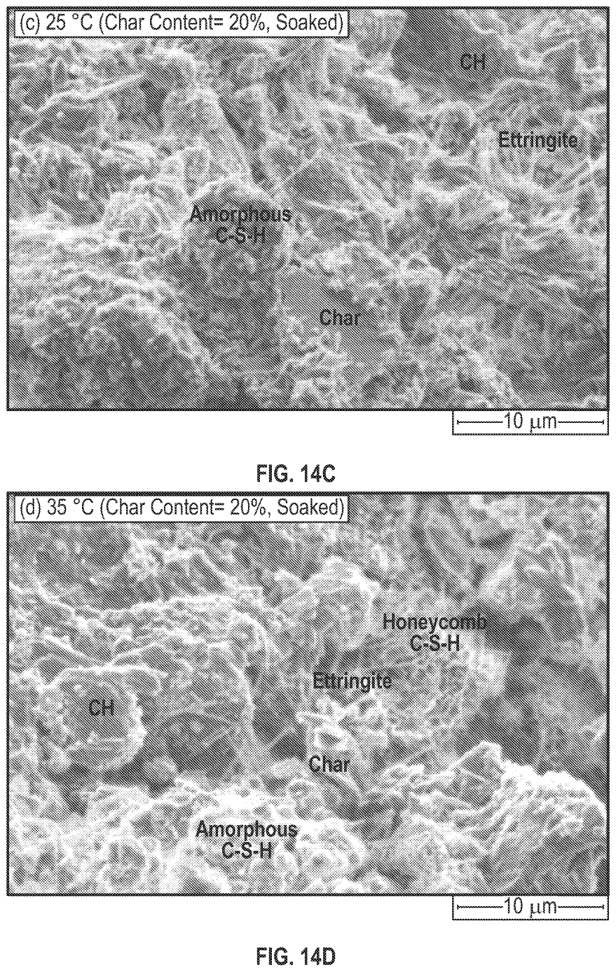

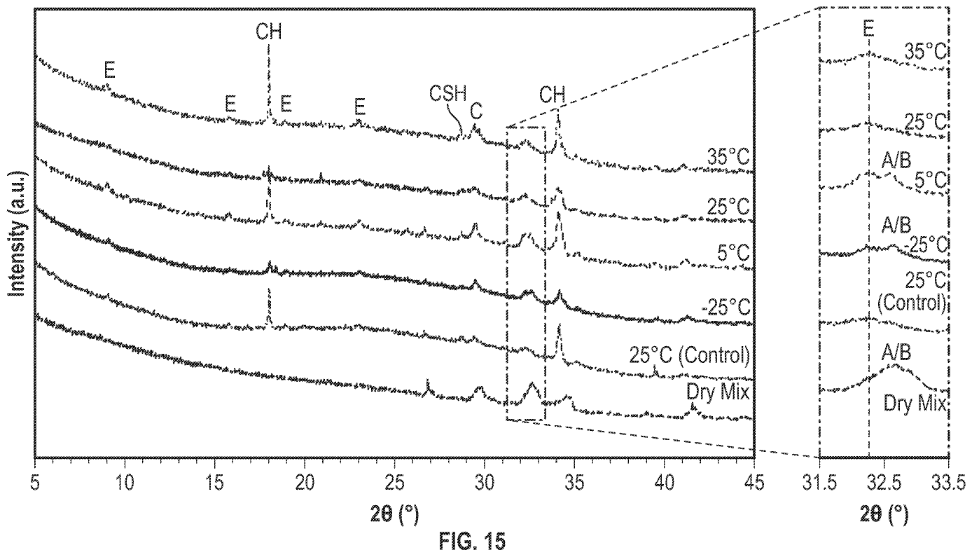

FIG. 14A is a scanning electron microscopy (SEM) micrograph of a PCG sample having 20% PC at −25 °C curing temperature for 28 days. FIG. 14B is a SEM micrograph of a PCG sample having 20% PC at 5 °C curing temperature for 28 days. FIG. 14C is a SEM micrograph of a PCG sample having 20% PC at 25 °C curing temperature for 28 days. FIG. 14D is a SEM micrograph of a PCG sample having 20% PC at 35 °C curing temperature for 28 days. FIG. 15 is a graph illustrating an X-ray diffraction (XRD) analysis of PCG samples cured for 28 days. Compared to the dry mixture of cement grout, the main cement hydration products (e.g., ettringite, C—S—H, and CH) are identified at different temperatures. Higher intensities of CH are observed in PCGs cured at 5 °C and 35 °C compared to PCGs cured at −25 °C and 25 °C. This may indicated a higher ratio of crystalline CH is formed since XRD measurements are effective for crystalline phase materials. The CH content in 28 day cured PCG at 5 °C and 35 °C is 30% to 42% lower than that of PCG cured at 25 °C. The morphology of CH in cement grout cured in air and water indicates that sufficient water enables the formation of crystalline CH. The PCG, however, the intensity of CH in PCG cured 5 °C and 35 °C is close to that of PCG cured at −25 °C and 25 °C. This may be beneficial for strength development by enabling hydration reactions when PCGs are at ambient temperature. The peaks for anhydrous cement components, including alite (C₃S) and belie (C₂S) are observed in PCGs at low temperatures of 5 °C and −25 °C, which may indicate that cement hydration has been delayed at low temperatures.

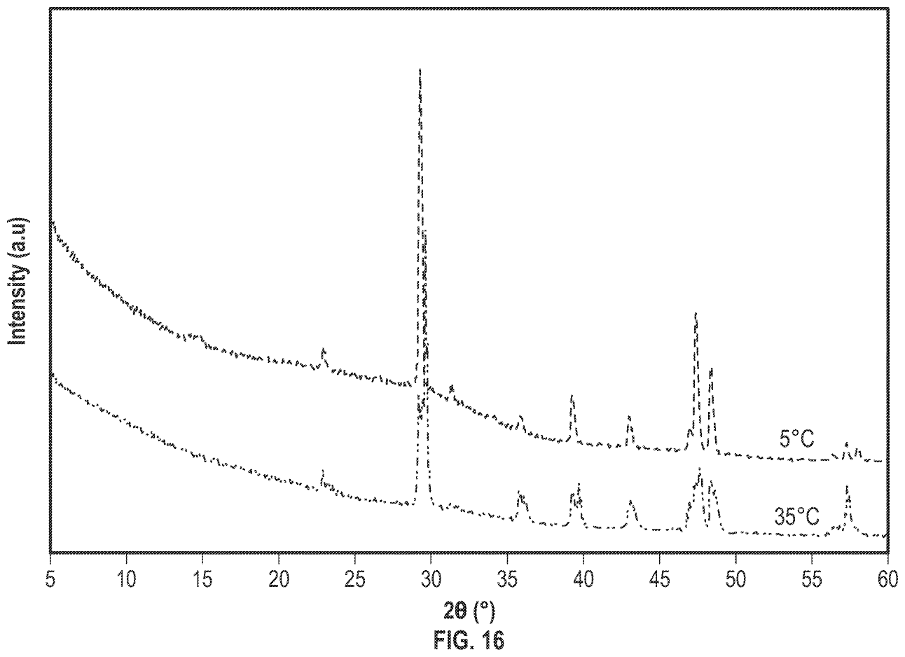

FIG. 16 is a XRD analysis of precipitates collected from PCG samples at different temperatures. After 28 days of curing at 5 °C or 35 °C, a large amount of white precipitate is observed. The white precipitate is calcite, with characteristic peaks confirmed by the XRD analysis. These precipitates are collected from ambient curing for PCG. This is consistent with the TG analysis which shows that, unlike the PCG cured at 25 °C, calcite contents of PCG cured at 5 °C and 35 °C decrease as curing time increases from 7 days to 28 days due to the precipitation of calcite.

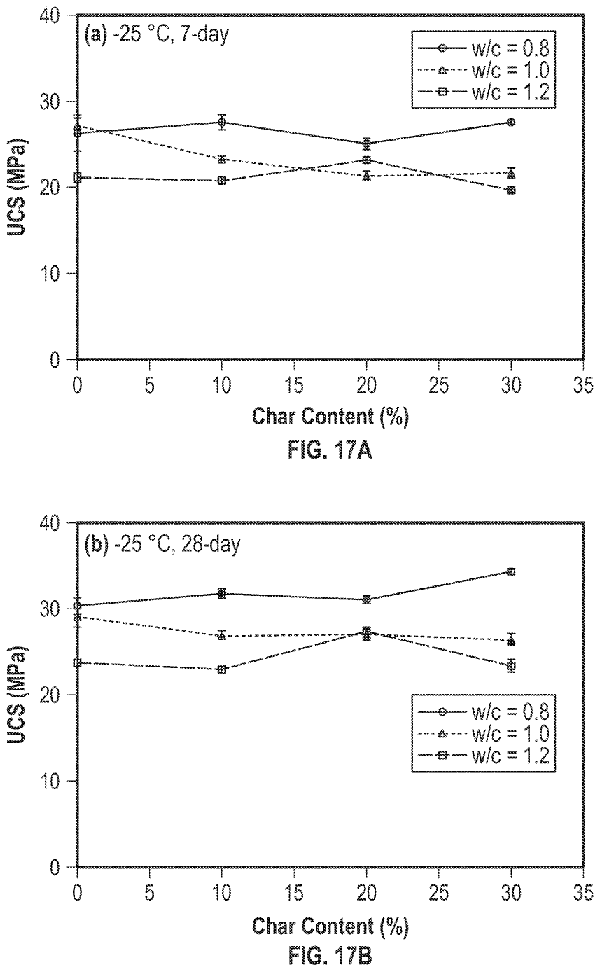

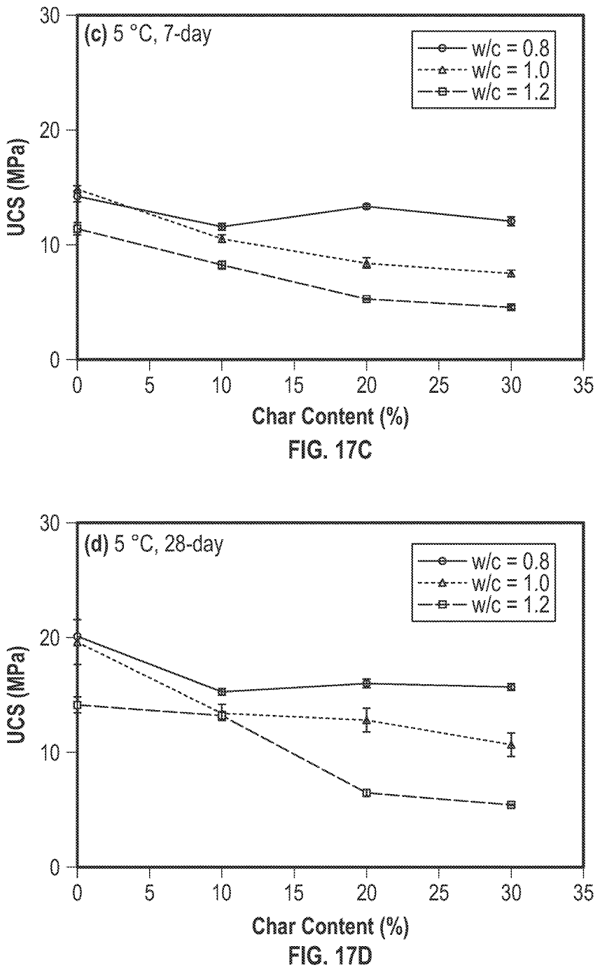

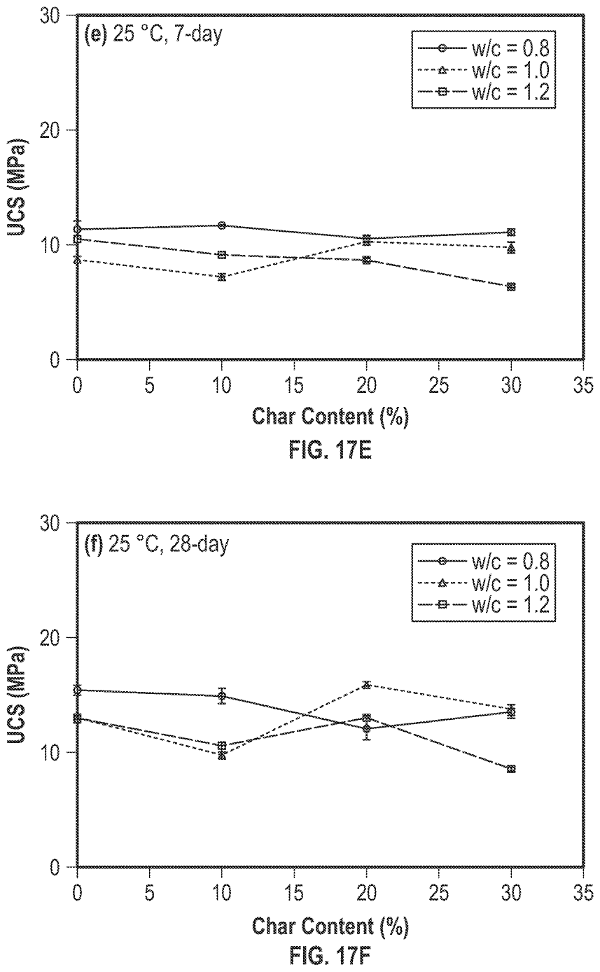

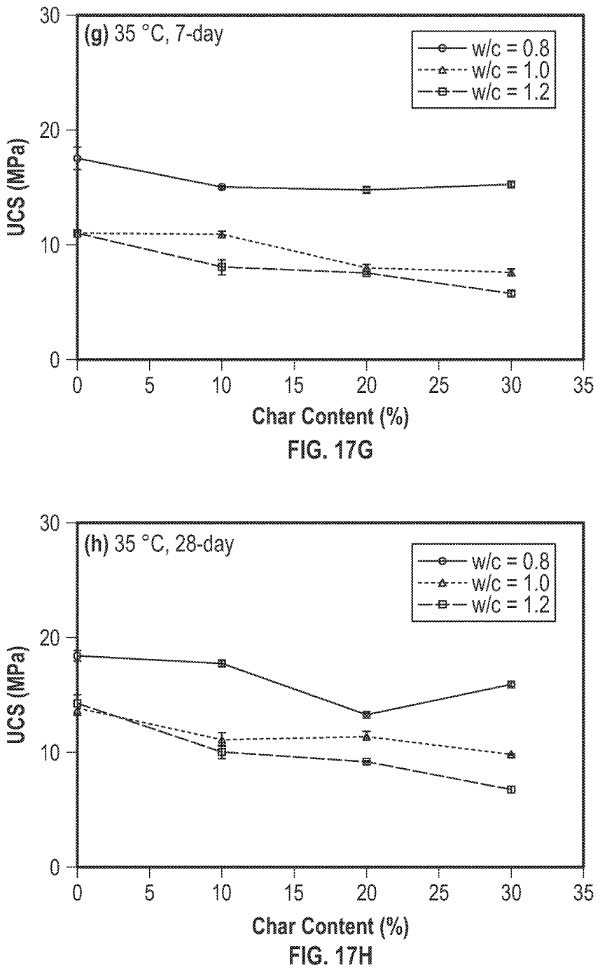

FIG. 17A is a graph illustrating the compressive strength versus PC content of PCG samples cured at −25 °C for 7 days. FIG. 17B is a graph illustrating the compressive strength versus PC content of PCG samples cured at −25 °C for 28 days. FIG. 17C is a graph illustrating the compressive strength versus PC content of PCG samples cured at 5 °C for 7 days. FIG. 17D is a graph illustrating the compressive strength versus PC content of PCG samples cured at 5 °C for 28 days. FIG. 17E is a graph illustrating the compressive strength versus PC content of PCG samples cured at 25 °C for 7 days. FIG. 17F is a graph illustrating the compressive strength versus PC content of PCG samples cured at 25 °C for 28 days. FIG. 17G is a graph illustrating the compressive strength versus PC content of PCG samples cured at 35 °C for 7 days. FIG. 17H is a graph illustrating the compressive strength versus PC content of PCG samples cured at 35 °C for 28 days.

At −25 °C with a w/c ratio of 0.8, the compressive strength increases with an increase in PC content. The compressive strength of PCG with 30% PC content is 5-13% higher than the cement grout. This may be due to more physically bound water attached to the porous PC, leading to higher strength from an increase in ice crystals formed and filling in the pores of the PC at subzero temperatures. For PCG samples with a w/c ratio of 1.0 and 1.2, the compressive strength decreases as the PC content increases. The compressive strength of PCG samples with 30% PC content is 1.6 to about 1.9% lower than that of cement grout at 28 days due to the higher w/c ratio. Unlike PCGs with a w/c ratio of 0.8 with newly formed ice that can be filed into the pre-existing empty pores in the PC, more free water can easily be held as the PC content in the PCG increases. This may lead to an excessive amount of ice forming micro-cracks instead of filling void areas due to the volumetric expansion of the ice. The compressive strength of 28 day cured cement grout and PCG is, on average, 11.5% and 20% higher than that of 7 day cured cement grout and PCG, respectively. The higher strength may indicate that the PC in the PCG at subzero temperatures can gradually release water to facilitate the cement hydration.

For PCG cured at low or high temperatures, the compressive strength decreases as the w/c ratio increases, which may be due to the increasing PC content and decreasing cement material content. For PCG samples cured at 25 °C, the effect of PC content on compressive strength does not show a general trend. For example, for a w/c ratio of 0.8, the compressive strength decreases as the PC content increases, which is similar to PCG cured at 5 °C and 35 °C. However, the w/c ratios of 1.0 and 1.2, the compressive strength of PCGs with PC contents of 20% is up to 23% higher than that of cement grout. This may be due to: 1) the effect of curing temperature on the microstructure of cement materials cured under water and increasing temperature from 10 °C to 60 °C leads to an increase in C—S—H content and decrease in ettringite content. This may be beneficial to the compressive strength of PCG. 2) The higher amount of PC increases the amount of air containing CO₂ trapped in the porous dry mixture, leading to the carbonation of C—S—H and CH. Compared to PCG cured at 5 °C and 35C, PCGs cured at 25 °C have more hydration products, increased calcite content, higher formation of dominant amorphous C—S—H, and less crystalline phase CH, which may lead to improved compressive strength. The highest strength in cement-based materials (mortar and concrete) cured at 5 °C, as compared to other higher curing temperatures (up to 40 °C) may cause an increase in coarse porosity due to denser C—S—H and less ettringite formation and an interlocking effect by the long needle ettringite cured at low temperatures at a longer curing time (greater than 28 days).

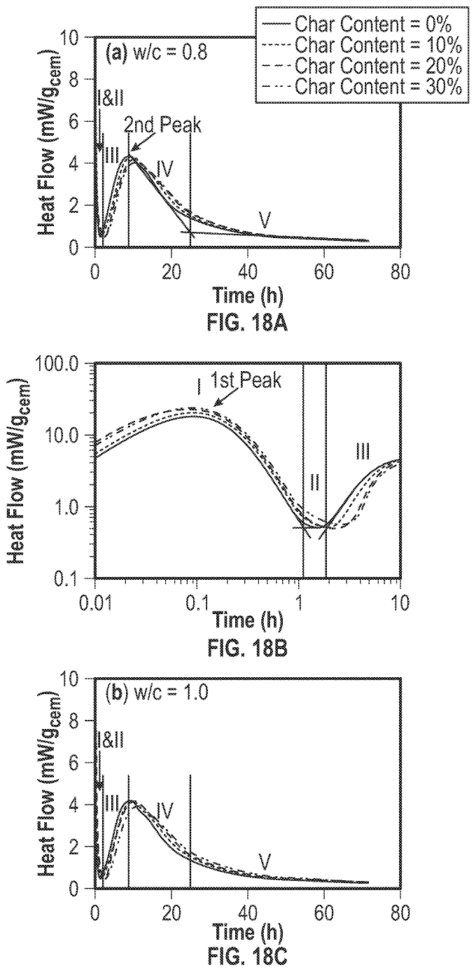

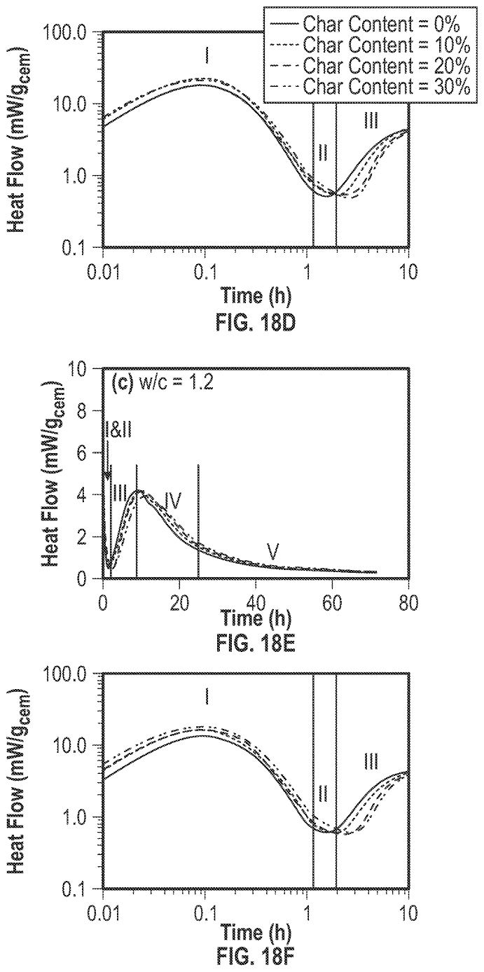

FIG. 18A is a graph illustrating the linear heat flow versus time of PCG samples having a w/c ratio of 0.8. FIG. 18B is a graph illustrating the logarithmic heat flow versus time of PCG samples having a w/c ratio of 0.8. FIG. 18C is a graph illustrating the linear heat flow versus time of PCG samples having a w/c ratio of 1.0. FIG. 18D is a graph illustrating the logarithmic heat flow versus time of PCG samples having a w/c ratio of 1.0. FIG. 18E is a graph illustrating the linear heat flow versus time of PCG samples having a w/c ratio of 1.2. FIG. 18F is a graph illustrating the logarithmic heat flow versus time of PCG samples having a w/c ratio of 1.2.

Portland cement hydration includes five periods I) initial reaction period; II) induction period; III) acceleration period; IV) deceleration period; and V) slow reaction period. The hydration periods are observed in the cement grout and the PCG. The boundary between the acceleration and deceleration period is defined as the second peak of the heat flow curve. The boundaries between other periods may be estimated using intersection points by extending approximately linear portions of curves from two consecutive periods. For cement grouts, the different crystal phases in cement clinker, celite (C₃A) has the highest reactivity and leads to the formation of ettringite in the presence of gypsum. Increasing the w/c ratio from 0.5 to 1.0 may not affect the C₃S hydration in the period, but may contribute to a higher degree of hydration at a longer period of time (>7 days) due to higher amounts of water available at the surface of C₃S. At the w/c ratio increases from 0.3 to 0.5, an increased amount of ettringite is formed at the hydration time up to 2 hours. It is believed that more water is available to dissolve calcium and sulphate ions and convey them to the aluminate surfaces, which may enable in the formation of ettringite. At a fixed w/c ratio, increasing PC content increases the heat flow peak (e.g., the first peak). This may be due to the nucleation and filler effect of the addition of porous PC with cement materials enables the formation of a cementitious matrix and the process of transporting ions and forming ettringite.

PCG have a delayed and longer induction period when compared to cement grout at the same w/c ratio. At a w/c of 0.8, the induction period of cement grout starts at 1.1 hours and lasts 0.7 hours. The induction period of PCG with a PC content of 30% starts at 1.4 hours and lasts 2 hours. This may be due to the heat of hydration in the initial reaction and induction period is related to the dissolution rate of alite (C₃S). The hydration mechanism of alite may dependent on the under-saturation of the solution, which is the primary mechanism until the end of the induction period with respect to the dissolving phase. This extension and delay of the induction period may also be due to Al³⁺ in solution being absorbed on the active sites to suppress the dissolution of alite at pH<12.5, which delays the time to reach induction period. A high pH (>13) may facilitate the precipitation of C—S—H and shorten the induction period. The concentration of Ca²⁺ in solution increases as the precipitation of C—S—H occurs. The solution is supersaturated with calcium hydroxide (CH), the rate of dissolution of alite becomes very slow. Due to the addition of PC with a pH of 9.2, a low pH in PCG cementitious matrix may hinder the solution supersaturated with CH forms and promotes the Al³⁺ absorption, which may lead to a delay and extension of the induction period in PCG.

The second peak may be comparable or higher in PCG with 10% PC content when compared to cement grout. The second peak is related to C—S—H formation (second stage) and the onset of the acceleration period corresponds to the main hydration reaction of alite or the rapid growth of C—S—H. This trend is consistent with the increase in compressive strength of PCG with 10% PC content, a PC particle size less than 300 μm, and curing time of 28 days as compared to cement grout. At the same w/c ratio, the second heat flow peak is delayed up to 25% as PC content increases. This may be due to the delay and extension of the induction period due to low pH in solution of PCGs and the large amount of free water absorbed by the PC due to capillary force instead of participating in cement hydration.

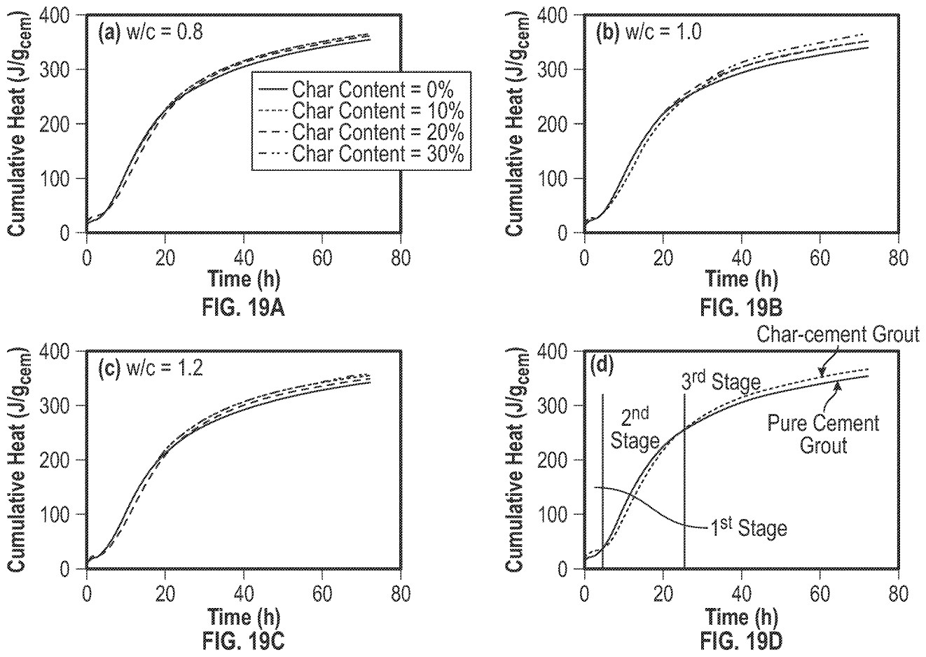

FIG. 19A is a graph illustrating the cumulative heat versus time relationship of PCG with a w/c ratio of 0.8. FIG. 19B is a graph illustrating the cumulative heat versus time relationship of PCG with a w/c ratio of 1.0. FIG. 19C is a graph illustrating the cumulative heat versus time relationship of PCG with a w/c ratio of 1.2. FIG. 19D is the cumulative heat versus time relationship of PCG and cement grout. The incorporation of PC does not significantly affect the total hydration heat of the cement materials, with less than an 8% difference between the PCG and cement grout. It is believed that PC is not a cementitious material. In the first stage, the PCG generates more cumulative heat than the cement grout. This may be due to the initial reaction where PC addition aids the cement hydration process by enabling the formation of a cementitious matrix and enhances the transport of ions and the formation of ettringite. PCG has a lower cumulative heat lower than that of cement grout at the second stage. This may be due to the delay and extension of the induction period resulting from the addition of PC, which has low pH. The PCG has a higher cumulative heat than cement grout in the third stage. This may be due to the water absorbed within the porous PC being gradually released, which promotes the hydration reaction. At 72 hours, the cumulative heat of PCG with w/c ratios of 0.8, 1.0, and 1.2 are 3.7%, 7.5% and 5%, respectively, higher than that of cement grout.

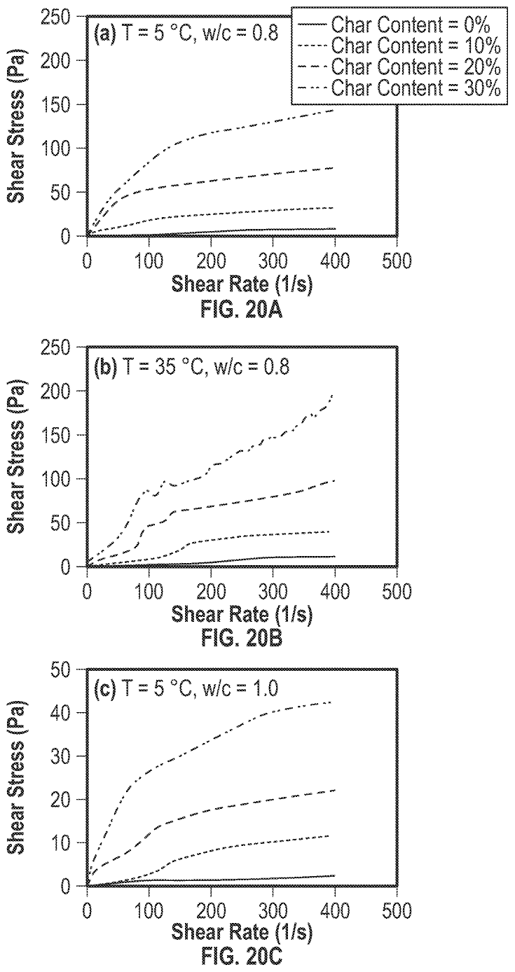

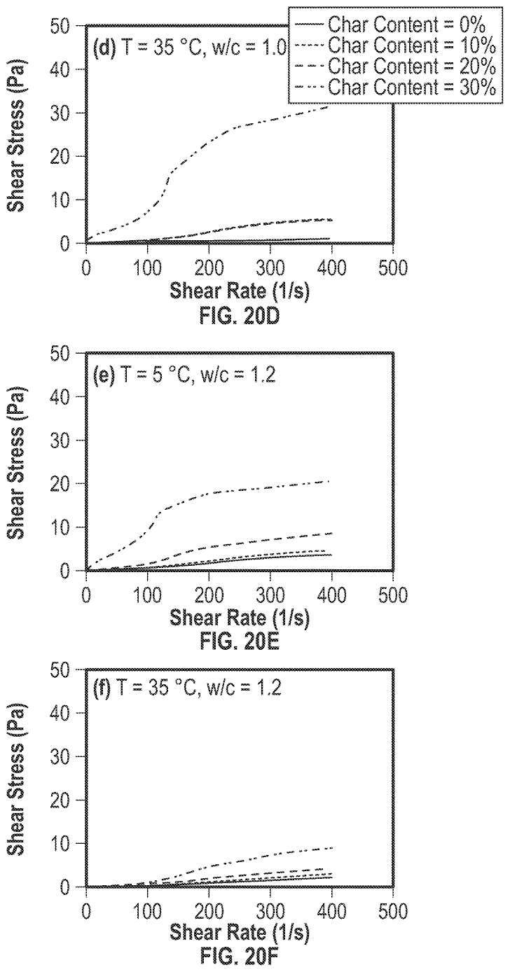

FIG. 20A is a graph illustrating the shear strain-shear stress relationship of PCG cured at 5 °C with a w/c ratio of 0.8. FIG. 20B is a graph illustrating the shear strain-shear stress relationship of PCG cured at 35 °C with a w/c ratio of 0.8. FIG. 20C is a graph illustrating the shear strain-shear stress relationship of PCG cured at 5 °C with a w/c ratio of 1.0. FIG. 20D is a graph illustrating the shear strain-shear stress relationship of PCG cured at 35 °C with a w/c ratio of 1.0. FIG. 20E is a graph illustrating the shear strain-shear stress relationship of PCG cured at 5 °C with a w/c ratio of 1.2. FIG. 20F is a graph illustrating the shear strain-shear stress relationship of PCG cured at 35 °C with a w/c ratio of 1.2.

Increasing the PC content increases the shear stress of PCG at a given shear rate, which may affect workability. At w/c ratios of 0.8 and 1.2, the average shear stress of PCG with a PC content of 30% is 9-19 and 3.5-7 times higher, respectively, than that of cement grout. The negative effect on increasing shear stress (i.e., decreasing workability) due to the addition of PC in PCG may be due to the negative charges of carboxyl function groups, high water holding capacity, irregular shape, and high carbon content of PC.

At a w/c ratio of 0.8, the average shear stress of cement grout at 5 °C and 35 °C is 5.2 Pa and 5.9 Pa, respectively. With increasing PC content up to 30%, an increase in curing temperature increases the shear stress of the PCG, i.e., the average shear stress of PCG with a PC content of 10% to 30% are 62.5 Pa and 64.6 Pa, respectively, at a w/c of 0.8. This is consistent with the effect of temperature on rheological behaviors of cement grouts with low w/c ratios. Cement grouts with a w/c ratio of 0.5-0.7 have an increase in shear stress with increasing temperatures due to the acceleration of the hydration reaction and the formation of a large amount of C—S—H gel. Ettringite precipitation may affect the rheological behavior of cement grout with a w/c ratio of 0.36. The hydration at higher temperature promotes more ettringite formation, which consumes water (i.e., decreases the w/c ratio) and increases the shear stress (i.e., the measured torque). As the w/c ratio increases to 1.0 and 1.2, an increasing temperature leads to a decrease in the average shear stress for both cement grout and PCGs. The average shear stress of cement grout at 5 °C and 35 °C are 1.4 Pa and 0.5 Pa, respectively. The average shear stress of PCG at 5 °C and 35 °C is 18 Pa and 8.1 Pa, respectively. Itis believed that in cement grouts with high w/c ratios (≥1.0), an increase in temperature expands the distance between molecules and decreases the molecular attraction, which reduces the internal friction and enchances the dispersion and lubrication of the free water in the cement grout. Additional PC in the PCG does not change the trend of rheological behaviors, but increases the magnitude of shear stress due to high water absorption and irregular PC shape.

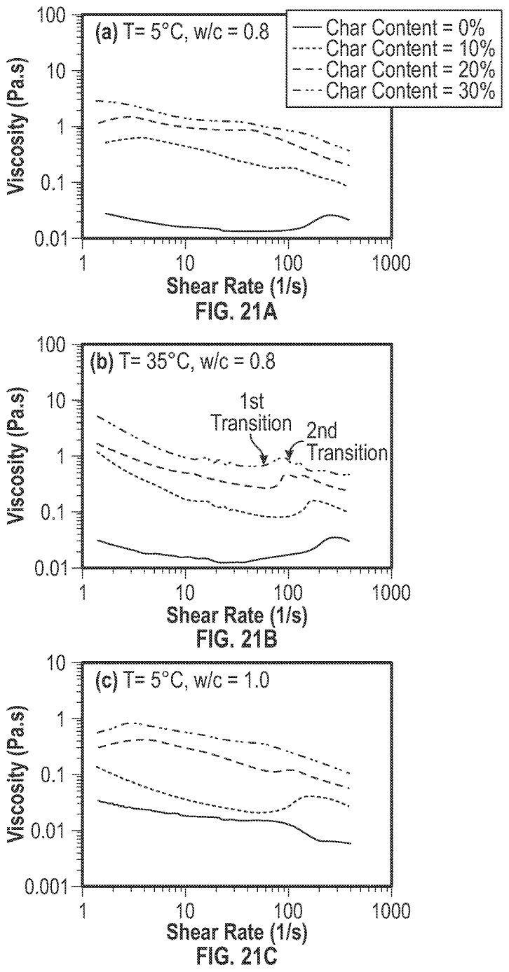

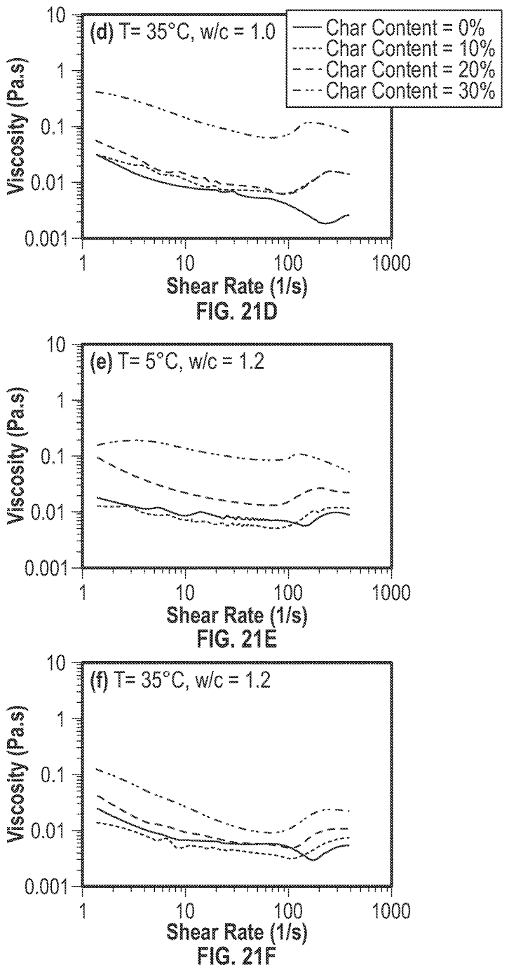

FIG. 21A is a graph illustrating the viscosity-shear rate relationship of PCG at cured at 5 °C with a w/c ratio of 0.8. FIG. 20B is a graph illustrating the viscosity-shear stress relationship of PCG cured at 35 °C with a w/c ratio of 0.8. FIG. 20C is a graph illustrating the viscosity-shear stress relationship of PCG cured at 5 °C with a w/c ratio of 1.0. FIG. 20D is a graph illustrating the viscosity-shear stress relationship of PCG cured at 35 °C with a w/c ratio of 1.0. FIG. 20E is a graph illustrating the viscosity-shear stress relationship of PCG cured at 5 °C with a w/c ratio of 1.2. FIG. 20F is a graph illustrating the viscosity-shear stress relationship of PCG cured at 35 °C with a w/c ratio of 1.2. The viscosity is calculated according to Equation (4).

At a w/c ratio of 0.8, the viscosity decreases (i.e., shear thinning behavior) in PCG as the shear rate increases to 400 s⁻¹. This may due to the reducing flocculation in PC hydrated cement material suspensions. At a curing temperature of 35 °C, two transitions in viscosity-shear rate of the PCGs are observed. The first transitions is from shear thinning to shear thickening. The second transition is from shear thickening to shear thinning. These two transitions may be related to the hydration products formed (i.e., first stage C—S—H gel and ettringite). As PC content increases from 10% to 30%, both transitions tend to begin earlier (e.g., at a lower shear rate). At a curing temperature of 5 °C, the transition is not observed in the viscosity-shear rate curve of PCGs. This may be due to the high temperature and addition of PC enabling the formation of hydration products, and therefore shortening the time (e.g. lowering the shear rate) to increase the viscosity, which is associated with the first transition. The irregular shapes and natural hydrophobicity surface of PC may enable PCGs with high PC content to reduce the flocculation in PC cement suspension, which shifts the second transition to an earlier time (e.g., lower shear rate). The two-transition behavior is observed in most PCGs with a w/c of 1.0 and all PCGs with a w/c ratio of 1.2. At a w/c ratio of 1.2, the viscosity of PCG with a PC content of 10% is lower than that of cement grout when the shear rate is less than 100 s⁻¹. This may be due to the high w/c ratio saturating the porous PC with free water in the PC cement suspension, which enhanced the lubrication and lowers the viscosity oat a macroscopic level.

In addition to the Bingham Model of Equation (5), rheological models for describing shear stress behaviors of grout include the Power Law of Equation (6), the Herschel-Bukley Model of Equation (7), and the modified Bingham Model (in quadratic form) of Equation (8):

ΣK\dot{γ}ⁿ (6)

τ=τ_{y}+K\dot{γ}ⁿ (7)

τ=τ_{y}+μₚ\dot{γ}+c\dot{γ}² (8)

Where K, n, and c are empirical constants. Using flow resistance (measured as the area under the shear stress-shear rate flow curve, i.e., \dot{γ}τ) may be more efficient for describing the behavior of cement grouts. A rheological model in power-law form based on the cumulative flow resistance (Σ\dot{γ}τ) is calculated from Equation (9):

log(Σ\dot{γ}τ)=A\dot{γ}ⁿ (9)

Where A and n are empirical constants.

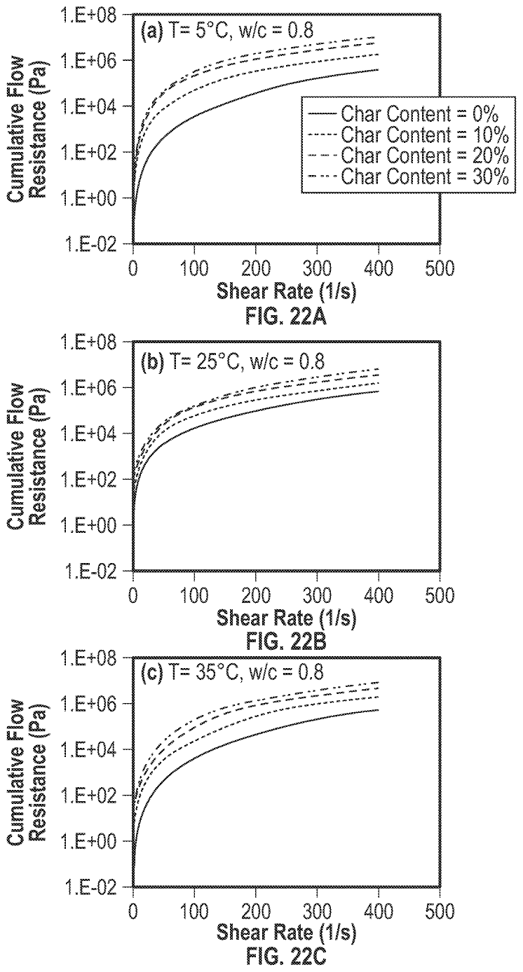

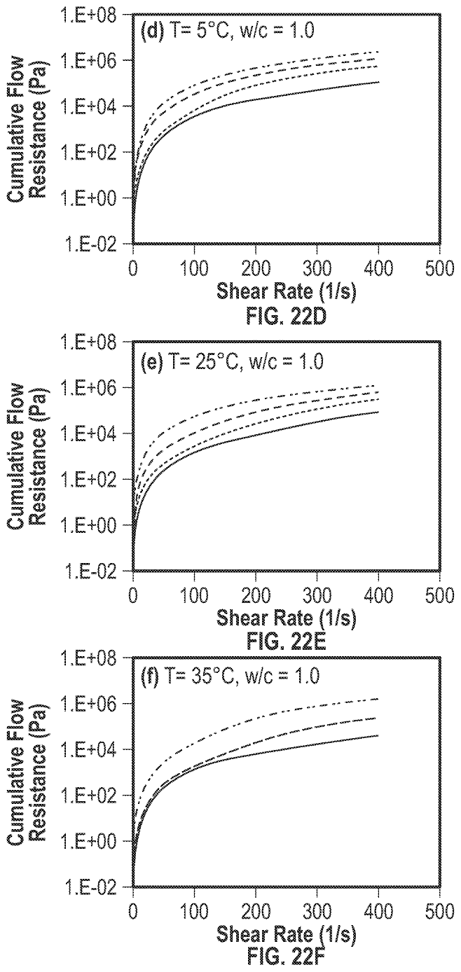

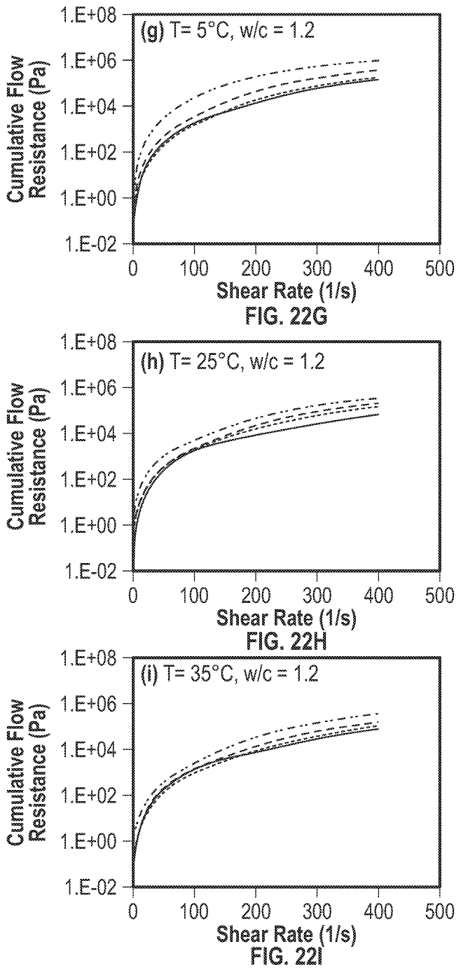

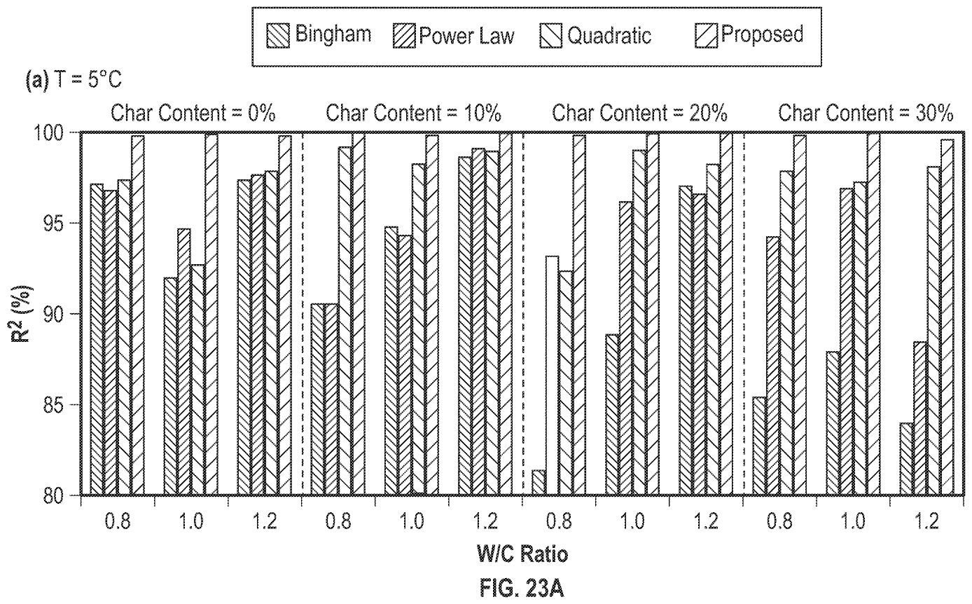

FIG. 22A is a graph illustrating the cumulative flow-shear rate relationship of PCG having a curing temperature of 5 °C and a w/c ratio of 0.8. FIG. 22B is a graph illustrating the cumulative flow-shear rate relationship of PCG having a curing temperature of 25 °C and a w/c ratio of 0.8. FIG. 22C is a graph illustrating the cumulative flow-shear rate relationship of PCG having a curing temperature of 35 °C and a w/c ratio of 0.8. FIG. 22D is a graph illustrating the cumulative flow-shear rate relationship of PCG having a curing temperature of 5 °C and a w/c ratio of 1.0. FIG. 22E is a graph illustrating the cumulative flow-shear rate relationship of PCG having a curing temperature of 25 °C and a w/c ratio of 1.0. FIG. 22F is a graph illustrating the cumulative flow-shear rate relationship of PCG having a curing temperature of 35 °C and a w/c ratio of 1.0. FIG. 22G is a graph illustrating the cumulative flow-shear rate relationship of PCG having a curing temperature of 5 °C and a w/c ratio of 1.2. FIG. 22H is a graph illustrating the cumulative flow-shear rate relationship of PCG having a curing temperature of 25 °C and a w/c ratio of 1.2. FIG. 22I is a graph illustrating the cumulative flow-shear rate relationship of PCG having a curing temperature of 35 °C and a w/c ratio of 1.2. For the PCG samples, as the shear rate increases, the slope of the cumulative shear resistance decreases. At a cure temperature of 25 °C, the cumulative shear resistance-shear rate curves are plotted based on the shear stress-shear rate data collected.

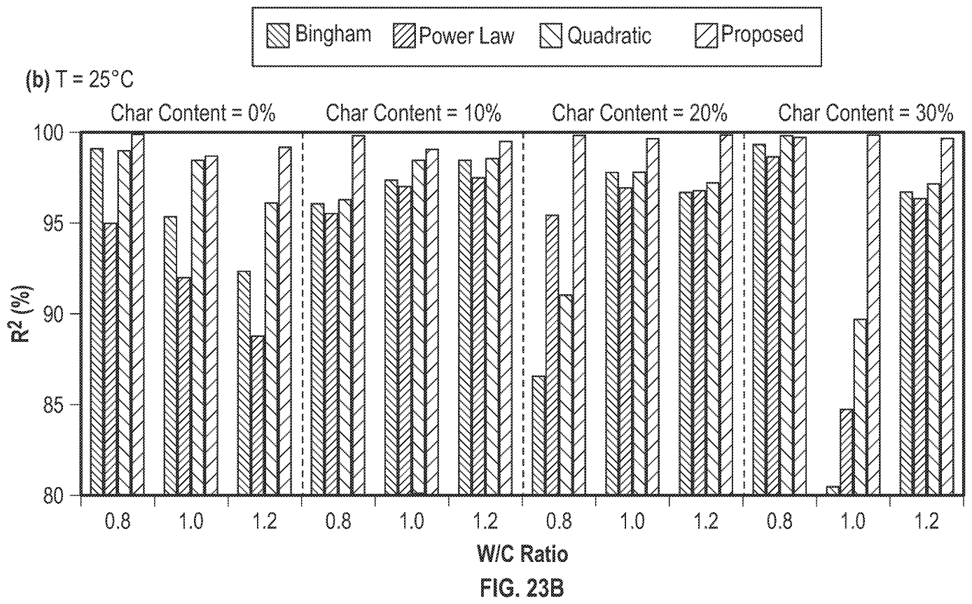

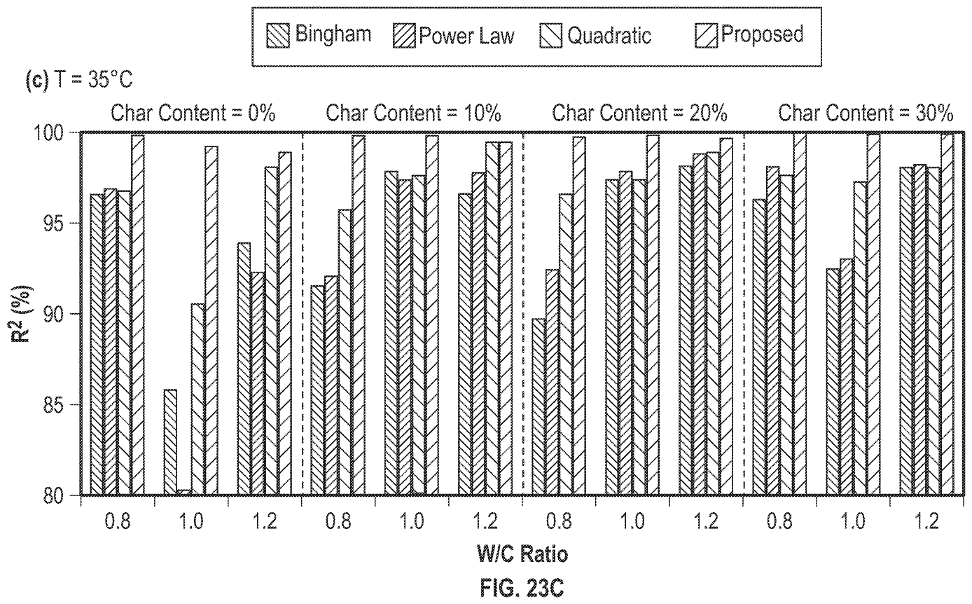

FIG. 23A is a graph illustrating the PCG samples by different rheological models and corresponding R² values having a curing temperature of 5 °C. FIG. 23B is a graph illustrating the PCG samples by different rheological models and corresponding R² values having a curing temperature of 25 °C. FIG. 23C is a graph illustrating the PCG samples by different rheological models and corresponding R² values having a curing temperature of 35 °C. Regardless of the w/c ratio, PC content, and curing temperature, the fitting performance of the cumulative flow resistance is consistently better than other models for describing rheological behaviors. The average R² value using cumulative flow resistance for all PCG samples is 99.7%, which is higher than that of other models.

### Embodiments Listing

The present disclosure provides, among other things, the following embodiments, each of which can be considered as optionally including any alternate embodiment.

Clause 1. A composition, comprising:
pyrolysis chad (PC);
cement materials; and
water, wherein the compositions is about 10% to about 50% PC by weight, about 50% to about 90% cement materials by weight, and having a water to cement (w/c) ratio of about 0.4 to about 1.2.

Clause 2. The composition of clause 1, wherein the PC is formed from a coal pyrolyzed at greater than about 450 °C.

Clause 3. The composition of clause 1, wherein the PC is formed from a coal pyrolyzed at about 850 °C.

Clause 4. The composition of clause 1, wherein the PC comprises at least about 75% to about 85% fixed carbon, about 12% to about 20% ash, and about 0.5% to about 2% volatile material.

Clause 5. The composition of clause 1, wherein the PC is formed from a coal pyrolyzed at about 850 °C.

The composition of claim 1, wherein the cement materials comprise Portland Type I cement or Portland Type II cement.

Clause 6. The composition of clause 1, wherein a bleeding percentage is less than about 5%.

Clause 7. The composition of clause 1, wherein a Marsh viscosity is about 20 sec to about 40 sec.

Clause 8. The composition of clause 1, wherein a density is about 1.4 g/cm³ and about 1.8 g/cm³.

Clause 9. The composition of clause 1, wherein a compressive strength is about 5 MPa to about 35 MPa.

Clause 10. A pyrolysis char grout, comprising:
a composition, the composition comprising:
   pyrolysis chad (PC);
   cement materials; and
   water, wherein the compositions is about 10% to about 50% PC by weight, about 50% to about 90% cement materials by weight, and having a water to cement (w/c) ratio of about 0.4 to about 1.2.

Clause 11. The composition of clause 1, wherein the PC is formed from a coal pyrolyzed at greater than about 450 °C.

Clause 12. The composition of clause 1, wherein the PC is formed from a coal pyrolyzed at about 850 °C.

Clause 13. The composition of clause 1, wherein the PC comprises at least about 75% to about 85% fixed carbon, about 12% to about 20% ash, and about 0.5% to about 2% volatile material.

Clause 14. The composition of clause 1, wherein the cement materials comprise Portland Type I cement or Portland Type II cement.

Clause 15. The composition of clause 1, wherein a bleeding percentage is less than about 5%.

Clause 16. The composition of clause 1, wherein a Marsh viscosity is about 20 sec to about 40 sec.

Clause 17. The composition of clause 1, wherein a density is about 1.4 g/cm³ and about 1.8 g/cm³.

Clause 18. A method of making a composition, comprising:
sieving a pyrolysis char (PC);
mixing the PC and cement materials to form a dry mixture;
mixing the dry mixture and water to for a PC grout (PCG) mixture;
curing the PCG mixture to form a PCG.

Clause 19. The method of clause 18, wherein the PC and cement materials are mixed for about 1 minute to about 5 minutes to form the dry mixture.

Clause 20. The method of clause 18, wherein the dry mixture and water are mixed for about 1 minute to about 5 minutes to form the PCG mixture.

Clause 21. The method of clause 18, wherein the PCG is cured at a temperature of about −25 °C and about 35 °C.

Clause 22. The method of clause 18, wherein the PC and cement materials are mixed for about 1 minute to about 5 minutes to form the dry mixture.

Clause 23. The method of clause 18, wherein the PC and the cement materials are mixed using a mixer rotating at about 30 RPMs to about 100 RPMs.

As is apparent from the foregoing general description and the specific aspects, while forms of the aspects have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, process operation, process operations, an element or a group of elements is preceded with the transitional phrase “comprising,” it is understood that we also contemplate the same composition or group of elements with transitional phrases “consisting essentially of,” “consisting of,” “selected from the group of consisting of,” or “Is” preceding the recitation of the composition, process operation, process operations, element, or elements and vice versa, such as the terms “comprising,” “consisting essentially of,” “consisting of” also include the product of the combinations of elements listed after the term.

For purposes of this present disclosure, and unless otherwise specified, all numerical values within the detailed description and the claims herein are modified by “about” or “approximately” the indicated value, and consider experimental error and variations that would be expected by a person having ordinary skill in the art. For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. For example, the recitation of the numerical range 1 to 5 includes the subranges 1 to 4, 1.5 to 4.5, 1 to 2, among other subranges. As another example, the recitation of the numerical ranges 1 to 5, such as 2 to 4, includes the subranges 1 to 4 and 2 to 5, among other subranges. Additionally, within a range includes every point or individual value between its end points even though not explicitly recited. For example, the recitation of the numerical range 1 to 5 includes the numbers 1, 1.5, 2, 2.75, 3, 3.80, 4, 5, among other numbers. Thus, every point or individual value may serve as its own lower or upper limit combined with any other point or individual value or any other lower or upper limit, to recite a range not explicitly recited.

While the foregoing is directed to embodiments of the present disclosure, other and further embodiments of the disclosure may be devised without departing from the basic scope thereof.

What is claimed is:

1. A composition, comprising:
pyrolysis chad (PC);
cement materials; and
water, wherein the compositions is about 10% to about 50% PC by weight, about 50% to about 90% cement materials by weight, and having a water to cement (w/c) ratio of about 0.4 to about 1.2.

2. The composition of claim 1, wherein the PC is formed from a coal pyrolyzed at greater than about 450 °C.

3. The composition of claim 1, wherein a bleeding percentage is less than about 5%.

4. The composition of claim 1, wherein density is about 1.4 g/cm³ and about 1.8 g/cm³.

5. The composition of claim 1, wherein a compressive strength is about 5 MPa to about 35 MPa.

6. A pyrolysis char grout, comprising:
a composition, the composition comprising:
pyrolysis chad (PC);
cement materials; and
water, wherein the compositions is about 10% to about 50% PC by weight, about 50% to about 90% cement materials by weight, and having a water to cement (w/c) ratio of about 0.4 to about 1.2.

7. The composition of claim 6, wherein the PC is formed from a coal pyrolyzed at greater than about 450 °C.

8. The composition of claim 6, wherein the PC is formed from a coal pyrolyzed at about 850 °C.

9. The composition of claim 6, wherein a density is about 1.4 g/cm³ and about 1.8 g/cm³.

10. The composition of claim 6, wherein a compressive strength is about 5 MPa to about 35 MPa.

11. A method of making a composition, comprising:
sieving a pyrolysis char (PC);
mixing the PC and cement materials to form a dry mixture;
mixing the dry mixture and water to for a PC grout (PCG) mixture;
curing the PCG mixture to form a PCG.

12. The method of claim 11, wherein the PC and cement materials are mixed for about 1 minute to about 5 minutes to form the dry mixture.

13. The method of claim 11, wherein the dry mixture and water are mixed for about 1 minute to about 5 minutes to form the PCG mixture.

14. The method of claim 11, wherein the PCG is cured at a temperature of about −25 °C and about 35 °C.

15. The method of claim 11, wherein the PC and the cement materials are mixed using a mixer rotating at about 30 RPMs to about 100 RPMs.
